(19) United States
(12) Patent Application Publication
(10) Pub. No.: US 2018/0075296 A1
(43) Pub. Date: Mar. 15, 2018

(54) METHOD OF RECOGNIZING CHARACTERS, CHARACTER RECOGNITION APPARATUS

(71) Applicant: FUJITSU LIMITED, Kawasaki-shi (JP)

(72) Inventors: Yugo MATSUDA, Machida (JP); Hideto HIGASHI, Yokohama (JP); Yasuhiro TSUYUKI, Numazu (JP)

(73) Assignee: FUJITSU LIMITED, Kawasaki-shi (JP)

(21) Appl. No.: 15/809,124

(22) Filed: Nov. 10, 2017

Related U.S. Application Data
(63) Continuation of application No. PCT/JP2015/063959, filed on May 14, 2015.

(51) Int. Cl. G06K 9/00; G06K 9/34

(52) U.S. Cl. CPC G06K 9/00416; G06F 3/04883; G06K 9/344

(57) ABSTRACT

A method of recognizing characters is disclosed, which includes displaying, on a screen on which a handwriting input can be accepted, an image that suggests a first input area and a second input area, the first input area and the second input area being partly overlapped; and recognizing a handwritten input in the first input area and a handwritten input in the second input area as different characters.

### CROSS-REFERENCE TO RELATED APPLICATIONS

This is a continuation of International Application No. PCT/JP2015/063959, filed on May 14, 2015, the entire contents of which are incorporated herein by reference.

### FIELD

The disclosure is related to a method of recognizing characters, a character recognition apparatus, etc.

### BACKGROUND

According to a handwriting input engine for character recognition using a plurality of input frames, for each of the plurality of input frames, character recognition is performed based on strokes obtained when a handwriting input is performed.

### CITIATION LIST

[Patent Document 1] Japanese Laid-open Patent Publication No. 2014-38384

### SUMMARY

According to an aspect of a disclosure, a method of recognizing characters is provided, the method comprising: displaying, on a screen on which a handwriting input can be accepted, an image that suggests a first input area and a second input area, the first input area and the second input area being partly overlapped; and recognizing a handwritten input in the first input area and a handwritten input in the second input area as different characters.

The object and advantages of the embodiment will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF DRAWINGS

FIG. 1 is a diagram explaining a program configuration according to an embodiment.

FIG. 2 is a diagram illustrating one form of a character recognition apparatus.

FIG. 3 is a diagram illustrating another form of the character recognition apparatus.

FIG. 4 is a diagram illustrating an example of a hardware resource configuration of the character recognition apparatus.

FIG. 5 is a diagram illustrating an example of a functional configuration of the character recognition apparatus.

FIG. 6 is a diagram illustrating an example of a screen of a display operation device.

FIG. 7 is a schematic flow chart explaining an example of processing by the character recognition apparatus.

FIG. 8 is a diagram illustrating an example of stroke information.

FIG. 9 is a diagram explaining coordinate information related to a stroke.

FIG. 10 is a diagram illustrating an example of allocation result.

FIG. 11 is a diagram illustrating an example of recognition result information.

FIG. 12 is a diagram illustrating an example of a screen on which a recognized character is displayed.

FIG. 13 is a schematic flow chart explaining an example of processing by the character recognition apparatus.

FIG. 14 is a schematic flow chart explaining an example of an input frame allocation process.

FIG. 15 is a diagram explaining a rectangular area.

FIG. 16 is a diagram explaining a combination candidate and an average evaluation value.

FIG. 17 is a diagram explaining an occupation rate.

FIG. 18 is a diagram explaining a combination candidate.

FIG. 19 is a diagram explaining an average evaluation value.

FIG. 20 is a diagram explaining an example of a way of allocating an overlapped stroke.

FIG. 21 is a diagram illustrating an input screen according to a first comparative example.

FIG. 22 is a diagram illustrating an input screen according to a second comparative example.

FIG. 23 is a diagram explaining a combination candidate according to the second comparative example.

FIG. 24 is a diagram explaining effects according to the embodiment.

FIG. 25 is a diagram explaining effects according to the embodiment.

FIG. 26 is a diagram explaining effects according to the embodiment.

FIG. 27 is an explanatory diagram of an input frame according to a first variant.

FIG. 28 is an explanatory diagram of an input frame according to a second variant.

FIG. 29 is an explanatory diagram of an input frame according to a third variant.

FIG. 30 is an explanatory diagram of an input frame according to a fourth variant.

FIG. 31 is an explanatory diagram of an input frame according to a fifth variant.

FIG. 32 is an explanatory diagram of an input frame according to a sixth variant.

FIG. 33 is an explanatory diagram of an input frame according to a seventh variant.

FIG. 34 is a diagram explaining a first application.

FIG. 35 is a diagram explaining a second application.

FIG. 36 is a diagram explaining a third application.

FIG. 37 is a diagram explaining an image that suggests first and second input frames.

### DESCRIPTION OF EMBODIMENTS

According to the related art, in a device of limited screen size, it becomes difficult to set a plurality of input frames. Therefore, in the case of performing the handwriting input a plurality of times using the same input frame, in accordance with the restriction of the screen size of the device, to input a character string composed of two or more characters, it is necessary to ensure a certain waiting time in order that the completion of handwriting input for each character is reliably detected. Therefore, it takes more time to input all the characters with such a configuration, as compared to inputting the characters all at once.

According to the related art, in order to make it possible to perform the handwriting input for a plurality of characters using the input frame for one character, it is necessary to examine, for each of a plurality of strokes obtained by the handwriting input, with a large number of combinations of the strokes, which character each stroke is to be allocated to. For example, in order to make it possible to perform the handwriting input for a plurality of characters using the input frame for one character, it is necessary to determine, based on the stroke information input by handwriting, the number of handwritten characters (i.e., a boundary between strokes for each character).

In the following, embodiments are described in detail with reference to appended drawings.

In the following description, not only Hiragana, Katakana, alphabet, Chinese characters, numbers, but also symbols fall within the concept of a character.

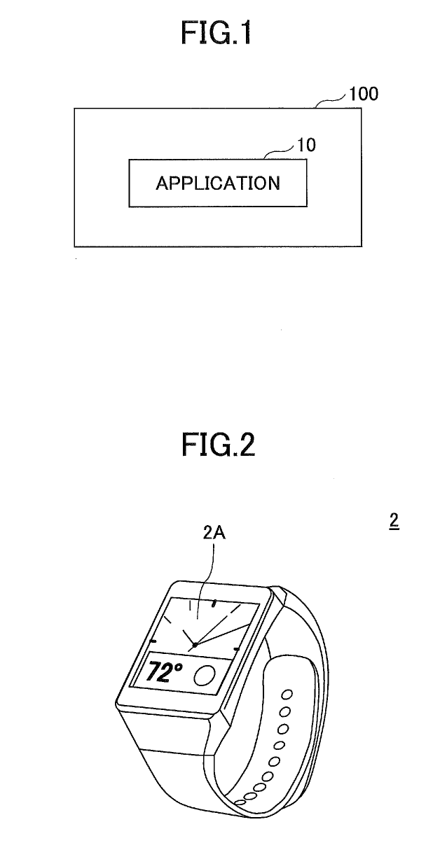

FIG. 1 is a diagram for explaining a program configuration according to an embodiment.

A program 100 includes an application 10. In the following description, an apparatus for executing the application 10 is represented as “character recognition apparatus 1”.

The application 10 includes one or more programs for recognizing, based on handwritten strokes on a screen, handwritten characters and displaying recognized characters. The “handwriting input” is an input method that expresses characters that a user wants to input by moving a hand (finger in the following example), and it is a concept including an input method using a stylus. Specifically, the application 10 recognizes characters that have been handwritten, based on the strokes that the user has handwritten on the screen.

The stroke input by handwriting corresponds to a trajectory (coordinate sequence) of a finger or a stylus at the time of handwriting input. One unit of the stroke is one continuous track (i.e., a trajectory of one handwriting) on coordinate axes and a time axis. The coordinate axis is on the input screen to be handwritten. One character can be represented by one or more strokes.

FIG. 2 is a diagram illustrating one form of a character recognition apparatus.

As illustrated in FIG. 2, for example, the character recognition apparatus 1 can be wearable to the user. In the example illustrated in FIG. 2, the character recognition apparatus 1 is a wristwatch type device 2 that can be worn on the user's arm with a strap, and is provided with a display unit 2A on which a touch operation is possible. In this case, the display unit 2A forms an input screen for an input by handwriting.

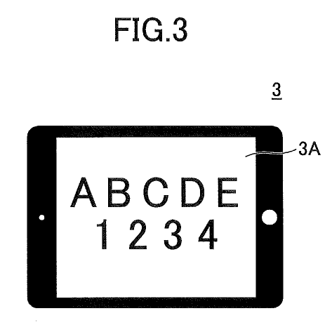

FIG. 3 is a diagram illustrating another form of the character recognition apparatus.

For example, as illustrated in FIG. 3, the character recognition apparatus 1 can be in the form of a terminal that can be carried by the user. In the example illustrated in FIG. 3, the character recognition apparatus 1 is a tablet-type device 3 and has a display unit 3A on which a touch operation is possible. In this case, the display unit 3A forms an input screen for an input by handwriting.

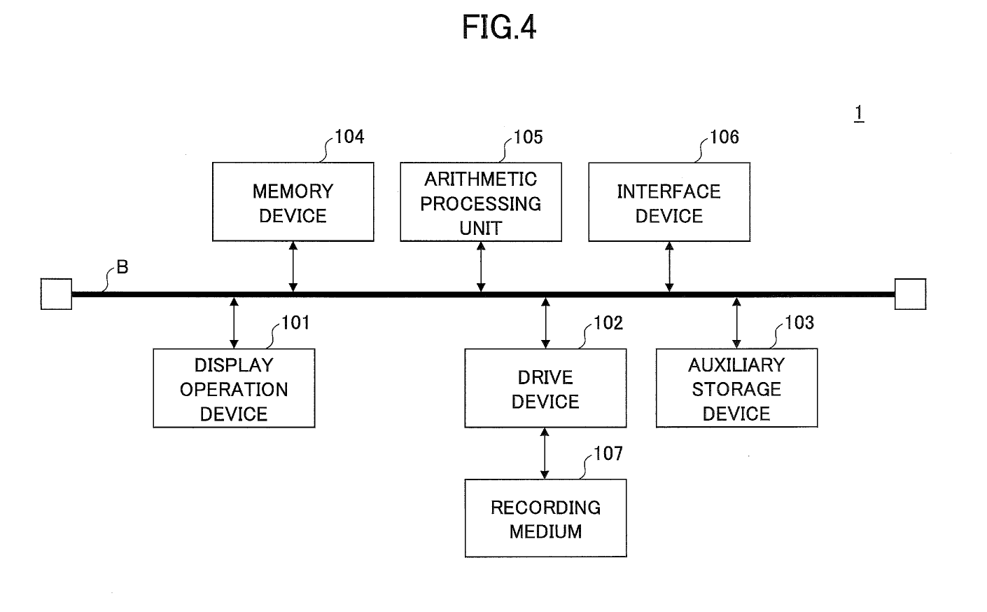

FIG. 4 is a diagram illustrating an example of the hardware configuration of the character recognition apparatus. In the example illustrated in FIG. 4, the character recognition apparatus 1 is configured by one computer. However, the character recognition apparatus 1 may be configured by a collection of one or more computers.

The character recognition apparatus 1 includes a display operation device 101, a drive device 102, an auxiliary storage device 103, a memory device 104, an arithmetic processing unit 105, and an interface device 106 such that they are mutually connected by a bus B.

The display operation device 101 is, for example, a touch panel or the like, and is used for input of various signals and display (output) of various signals. In the case of the device 2 illustrated in FIG. 2, the display operation device 101 is realized by the display unit 2A. In the case of the device 3 illustrated in FIG. 3, the display operation device 101 is realized by the display unit 3A. The interface device 106 includes a model, a LAN card, etc., and is used for connecting to a network.

The application 10 is at least a part of various programs for controlling the character recognition apparatus 1. These programs are provided by distribution via a recording medium 107 or downloaded from the network, for example. The recording medium 107 having the application 10 stored therein may be of various types, including a recording medium for optically, electrically or magnetically storing information, such as a CD-ROM, a flexible disk, a magneto-optical disk, and a semiconductor memory for electrically storing information, such as a ROM, a flash memory.

When the recording medium 107 storing the application 10 is set in the drive device 102, each program is installed in the auxiliary storage device 103 from the recording medium 107 via the drive device 102. Each program downloaded from the network is installed in the auxiliary storage device 103 via the interface device 106.

The auxiliary storage device 103 stores the installed application 10 and stores an OS (Operating System) which is basic software, necessary files, data, and the like. The memory device 104 reads and stores the respective programs in the auxiliary storage device 103 at the time of activation of each program. Then, the arithmetic processing unit 105 implements various processes as described hereinafter in accordance with each program stored in the memory device 104.

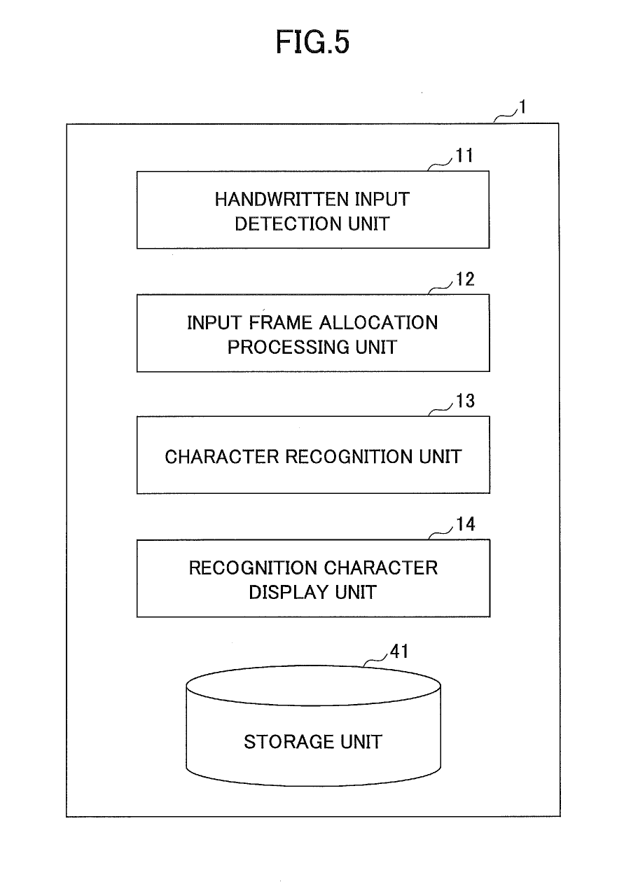

FIG. 5 is a diagram illustrating an example of a functional configuration of the character recognition apparatus. The character recognition apparatus 1 includes a handwritten input detection unit 11, an input frame allocation processing unit 12, a character recognition part 13, a recognition character display unit 14, and a storage unit 41.

The handwriting input detection unit 11, the input frame allocation processing unit 12, the character recognition part 13, and the recognition character display unit 14 are realized by the arithmetic processing unit 105 executing the application 10. The storage unit 41 is realized by the auxiliary storage device 103 and the memory device 104.

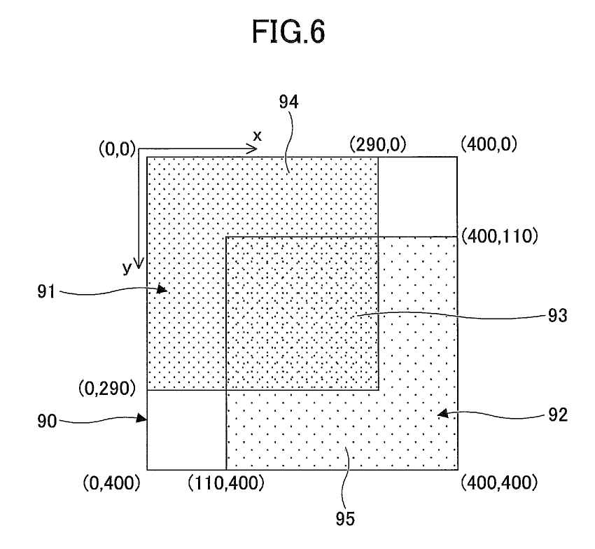

The handwriting input detection unit 11 detects a handwriting input to a handwriting input area in the display operation device 101. The handwriting input detection unit 11 receives a plurality of strokes by handwriting input to the input screen. An input frame for handwriting input (see FIG. 6) is displayed in the area where handwriting input is possible. The input frame functions as a guide for advising the user to perform handwriting input of one or more strokes related to one character in the area within the input frame. Note that the area in which handwriting input is possible may be set on the entire input screen of the display operation device 101 or may be set as a part of the input screen. Hereinafter, as an example, it is assumed that the area in which handwriting input is possible is set over the entire input screen because the screen size of the display operation device 101 is relatively small.

FIG. 6 is a diagram illustrating an example of an input screen of the display operation device 101 on which input frames are displayed.

In the example illustrated in FIG. 6, a first input frame 91 and a second input frame 92 which partially overlap are displayed on the input screen 90 of the display operation device 101. The first input frame 91 and the second input frame 92 have an overlapped area 93. That is, the first input frame 91 includes the overlapped area 93 overlapping the second input frame 92 and a non-overlapped area 94 (hereinafter also referred to as “a first non-overlapped area 94”) with respect to the second input frame 92. Further, the second input frame 92 includes the overlapped area 93 and a non-overlapped area 95 (hereinafter also referred to as “a second non-overlapped area 95”) with respect to the first input frame 91. The first input frame 91 is arranged at a left and upper corner of the input screen 90 and the second input frame 92 is arranged at a right and lower side corner of the input screen 90, such that the right and lower side corner of the first input frame 91 overlaps with a left and upper side corner of the second input frame 92

Note that, when the first input frame 91 and the second input frame 92 are displayed in the area in which handwriting input is possible, the entire area in the first input frame 91 is an area (an example of a first input area) in which handwriting input is possible, and the entire area in the second input frame 92 is an area (an example of a second input area) in which handwriting input is possible.

Note that each coordinate value that defines the area of the first input frame 91 and the area of the second input frame 92 is held in the storage unit 41. In the following, as an example, as illustrated in FIG. 6, an input screen 90 having coordinate values of 401×401 points is assumed. An origin of the coordinate system is fixed at the upper left corner of the input screen 90 as illustrated in FIG. 6, for example. As illustrated in FIG. 6, when the first input frame 91 includes an area surrounded by line segments connecting the coordinate values (0, 0), (290, 0), (290, 290) and (0, 290), coordinate values of these four points are stored in the storage unit 41. Similarly, on the same input screen 90, when the second input frame 92 is surrounded by line segments connecting coordinate values (110, 110), (400, 110), (400, 400) and (110, 400) of the four points, the coordinate values of these four points are stored in the storage unit 41.

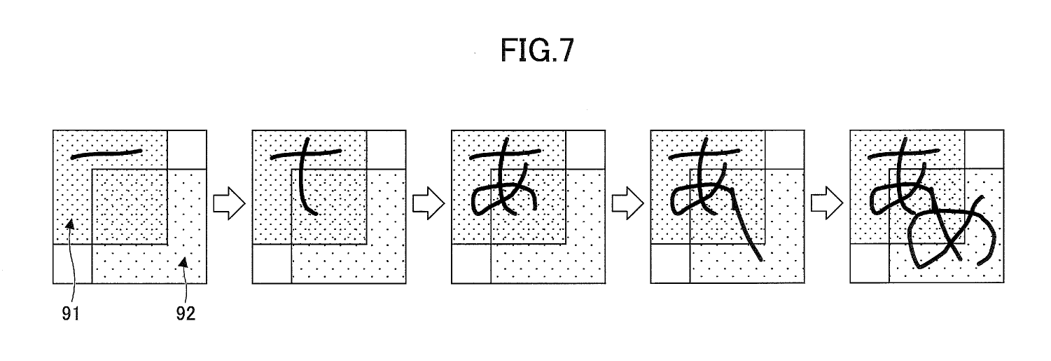

FIG. 7 is an explanatory diagram of a stroke when two characters “ [symbol] ” and “ [symbol] ” are handwritten on the input screen 90. In FIG. 7, an example of a state of the input screen 90 when each stroke is handwritten is illustrated in time progression from left to right (from bottom to top on the paper). In FIG. 7, from the left, a state in which the first stroke of “ [symbol] ” is input to the first input frame 91, a state in which the second stroke of “ [symbol] ” is input to the first input frame 91, and a state in which the third stroke of “ [symbol] ” is input to the first input frame 91 are illustrated in this order. Furthermore, a state in which the first stroke of “ [symbol] ” is input to the second input frame 92 and a state in which the second stroke of “ [symbol] ” is input to the first input frame 91 are illustrated in this order. Note that, as illustrated in FIG. 7, each stroke input by handwriting on the input screen 90 is rendered on the input screen 90 based on the coordinate information.

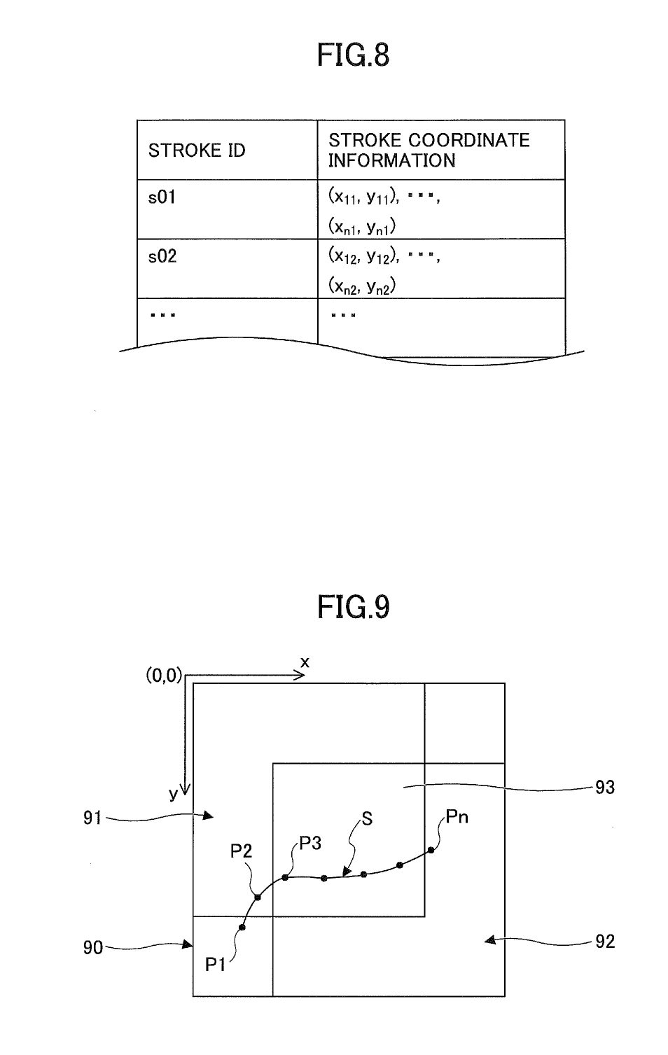

Upon detecting the handwriting input, the handwriting input detection unit 11 generates stroke information indicating strokes related to the handwriting input, and stores the generated stroke information in the storage unit 41. The stroke information includes coordinate information of each stroke. In the example illustrated in FIG. 8, the coordinate information is given an ID (stroke ID) for each obtained stroke, and is managed on a stroke ID basis. Here, as an example, the stroke ID also represents the time series order between strokes. However, the stroke information may separately include time information such as a time stamp.

For example, in the example illustrated in FIG. 8, “s01”, “s02”, . . . correspond to the stroke ID and the numerals (for example, “01” etc.) after “s” represent the time series order of each stroke. The coordinate information on each stroke includes a coordinate string of a plurality of points representing the stroke. In the example illustrated in FIG. 8, for example, the coordinate information of the stroke ID=s01 includes a coordinate sequence of n coordinate values (x n 11, y 11), . . . , (x n1, y n1). That is, the stroke of the stroke ID=s01 is formed by connecting the respective coordinates of (x n 11, y 11), . . . , (x n1, y n1) of the coordinate sequence. As illustrated in FIG. 9, the n coordinate values correspond to the respective coordinate values of the points P1, . . . , Pn forming the stroke S relating to the stroke ID =s01. Note that n is a variable, which can vary for each stroke.

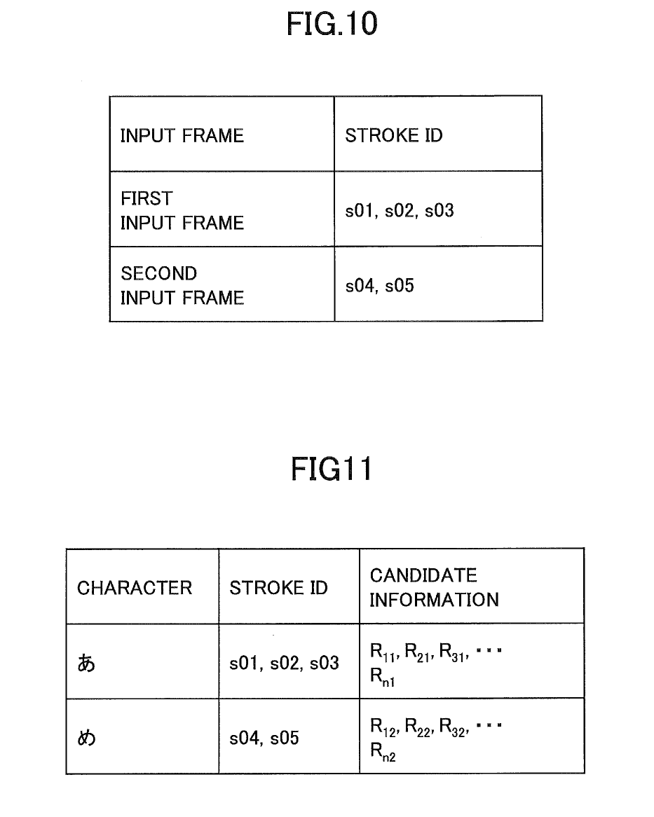

The input frame allocation processing unit 12 performs an input frame allocation process. The input frame allocation process includes allocating each of the plurality of strokes detected by the handwriting input detection unit 11 to one of the first input frame 91 and the second input frame 92. For example, as illustrated in FIG. 10, the input frame allocation processing unit 12 generates allocation result information indicating the relationship between the allocated stroke and the input frame, and stores the generated allocation result information in the storage unit 41. In the example illustrated in FIG. 10, the allocation result information is such that three stroke IDs “s01”, “s02”, and “s03” are allocated to the first input frame 91 and two stroke IDs “s04”and “s05” are allocated to the second input frame 92. A specific example of the input frame allocation process will be described hereinafter.

The character recognition part 13 recognizes, based on the plurality of strokes detected by the handwriting input detection unit 11 and the input frame (the first input frame 91 or the second input frame 92) to which the respective strokes are allocated, each character that has been handwritten on an input frame basis. For example, when recognizing one character based on one or more strokes allocated to an input frame, the character recognition part 13 creates a plurality of candidates that can be formed by the one or more strokes, and calculates an evaluation value (score) representing likelihood of each candidate. Then, the character recognition part 13 outputs the candidate having the highest evaluation value as the first candidate (recognized character). Note that the recognized character generally corresponds to the first candidate (the likeliest candidate), and the correction candidates correspond to the second-most likely to be the second and subsequent.

For example, as illustrated in FIG. 11, the character recognition part 13 generates recognition result information indicating a recognition result, and stores the generated recognition result information in the storage unit 41. The recognition result information represents a correspondence between the strokes used for recognition and the character (recognized character) recognized by the strokes. The example illustrated in FIG. 11 indicates that the character “SD” has been recognized based on the combination of the three strokes related to the stroke IDs “s01”, “s02”, and “s03”. In addition, it indicates that the character “ [symbol] ” has been recognized based on the combination of the two strokes related to the stroke IDs “s03” and “s04”.

Note that, as illustrated in FIG. 11, the recognition result information may include candidate information. The candidate information represents characters of a correction candidate for a recognized character. For example, in the example illustrated in FIG. 11, the candidate information related to each recognized character “ [symbol] ” and “ [symbol] ” is illustrated. In the example illustrated in FIG. 11, for example, the candidate information relating to “ [symbol] ” includes n correction candidate characters “R 11”, “R 21”, “R 31”, “R n1”. This means that, in recognizing the recognized character “ [symbol] ”, n correction candidate characters “R 11”, “R 21”, “R 31”, . . . , “R n1” are obtained as the second and subsequent candidates.

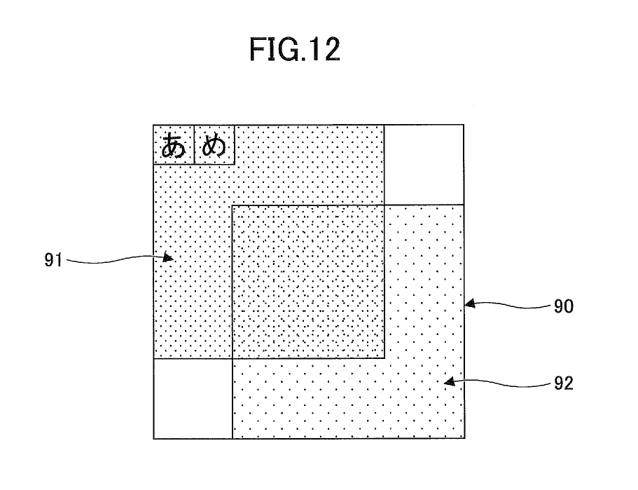

The recognition character display unit 14 displays the recognized characters based on the recognition result information. That is, the recognition character display unit 14 displays one or more recognized characters in the display area of the display operation device 101 based on the recognition result information. FIG. 12 is a diagram schematically illustrating an example of the input screen 90 of the display operation device 101 on which recognized characters are displayed. In the example illustrated in FIG. 12, two recognized characters “ [symbol] ” and “ [symbol] ” are displayed. The display area of the recognized character may be output to an arbitrary location on the screen of the display operation device 101. Further, the area in which the recognized characters can be displayed on the input screen 90 may be set to the entire input screen 90 or may be set to a part of the input screen 90. In the example illustrated in FIG. 12, the recognized characters “ [symbol] ” and “ [symbol] ” are displayed in an area in the first input frame 91 on the input screen 90. Note that, even in this state, a new handwriting input may be enabled in the first input frame 91.

Next, an operation example of the character recognition apparatus 1 will be described.

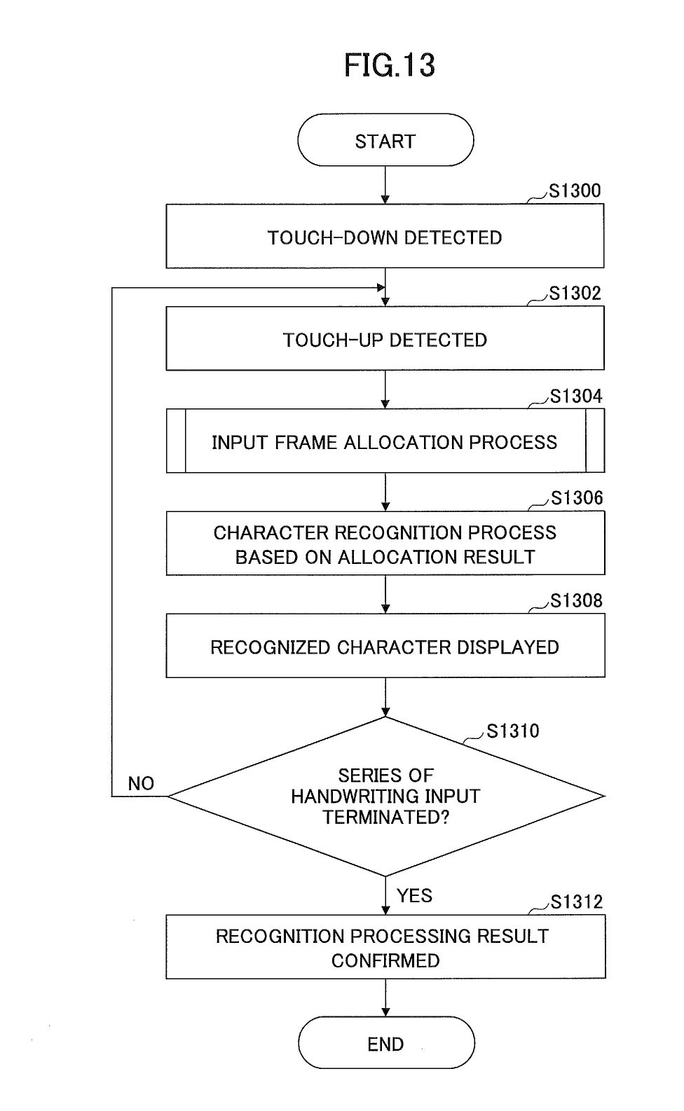

FIG. 13 is a schematic flow chart for explaining an example of processing by the character recognition apparatus.

In step S1300, the handwriting input detection unit 11 detects a start of one stroke (touch-down event) by handwriting input. The touch-down event is detected, for example, when a touch input to the input screen 90 is detected in a state in which a touch input has not been detected for a predetermined time or longer.

In step S1302, the handwriting input detection unit 11 detects the end of the stroke (touch-up event) detected in step S1300. The touch-up event is detected when the touch input to the input screen 90 is not detected. In this way, each time the input detection unit 11 detects one stroke (one touch event), the processing from step S1304 to step S1308 is executed until a series of handwritten inputs including the one stroke is completed. However, the processing in steps S1304 to S1308 may be executed collectively for the plurality of strokes each time a plurality of strokes are detected.

In step S1304, the input frame allocation processing unit 12 executes an input frame allocation process. Note that, each time the input frame allocation process is performed for one stroke, the input frame allocation processing unit 12 updates the allocation result information (see FIG. 10) related to the current series of handwritten inputs. The current series of handwritten inputs means handwriting input performed from the touch-down event detected in step S1300 until it is determined in step S1310 that a touch input is not detected for a predetermined time or longer. The series of handwritten inputs involves consecutive inputs of one or more strokes. A specific example of the input frame allocation process will be described hereinafter.

In step S1306, the character recognition part 13 recognizes the characters handwritten on an input frame basis, based on the allocation result information (see FIG. 10) related to the current series of handwritten inputs. For example, the character recognition part 13 performs a recognition process each time a stroke is added to the allocation result information while the current series of handwritten inputs is continued. In this case, each time a stroke is added, a recognition processing result (recognized character) may be changed. However, the character recognition part 13 may collectively perform the recognition process at the stage when the series of handwritten inputs is finished (the stage at which the allocation result is confirmed).

In step S1308, the recognition character display unit 14 displays the recognized character based on the recognition processing result obtained in step S1306.

In step S1310, the handwriting input detection unit 11 determines whether the touch input is not detected for a predetermined time, that is, whether the series of handwritten inputs has ended. For example, such detection is performed by the handwriting input detection unit 11 when handwriting input is not detected for a certain period of time. The certain period of time is significantly longer than a period between strokes (temporary period during which there is no touch input) that can occur at the time of handwriting two or more strokes continuously. If it is determined that the series of handwritten inputs has been completed, the process goes to step S1312, and otherwise (that is, when a new touch-down event is detected), the process returns to step S1302 to execute the process described above with respect to the new stroke.

In step S1312, the character recognition part 13 confirms the current recognition processing result with respect to the current series of handwritten inputs. Accordingly, the process of FIG. 13 for the current series of handwritten inputs is completed.

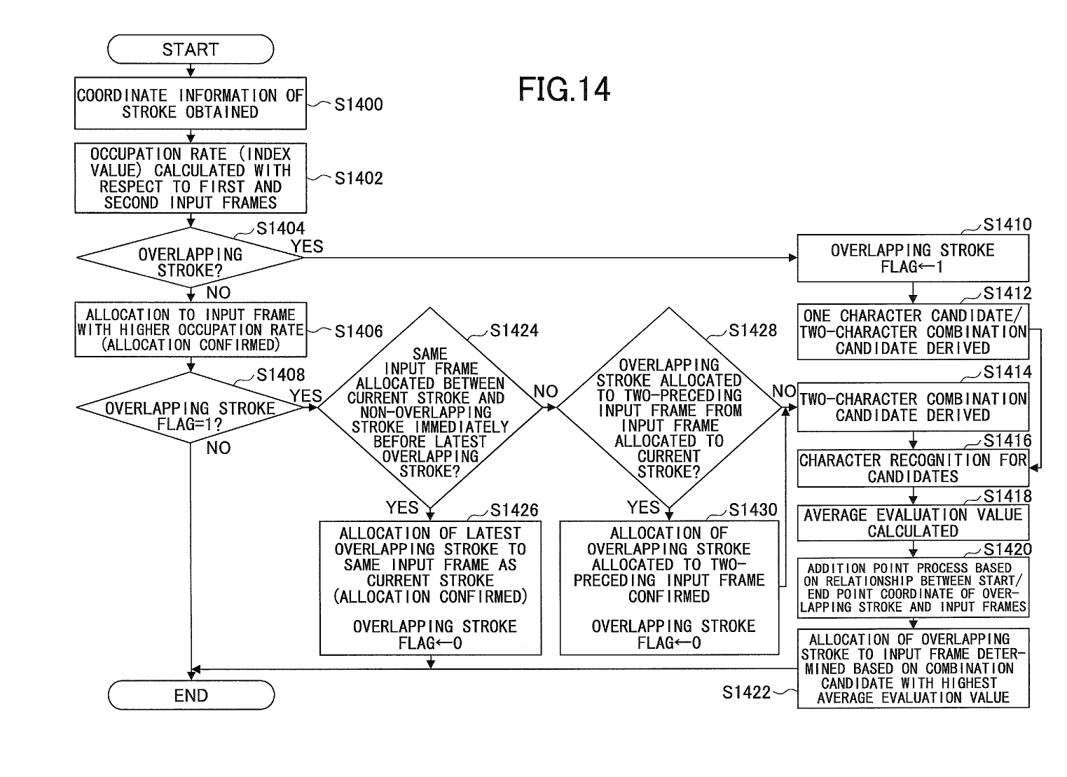

FIG. 14 is a schematic flow chart for explaining an example of an input frame allocation process.

The processing illustrated in FIG. 14 can be applied not only to a case where handwriting input for only two characters is performed consecutively in the order of the first input frame 91 and the second input frame 92, but also to a case where handwriting input is performed consecutively for three or more characters alternately in the first input frame 91 and the second input frame 92. As an example of the latter, for example, when the user performs handwriting input for the first character in the first input frame 91, performs handwriting input for the second character in the second input frame 92, performs handwriting input for the third character in the first input frame 91, performs handwriting input for the fourth character into the second input frame 92, and so forth.

In the processing illustrated in FIG. 14, as will be described hereinafter, as an example, when handwriting input is performed consecutively for three or more characters alternately in the first input frame 91 and the second input frame 92, the input frame allocation process is performed on the latest two input frames basis. Accordingly, in the following description, for example, the term “two(second)-preceding input frame” can be understood for such a situation in which the strokes are sequentially allocated to the first input frame 91, the second input frame 92, the first input frame 2n 91, the second input frame 92, and so on. For example, when the current stroke is the stroke of the third character and is allocated to the first input frame 91, the “two-preceding input frame” with respect to the first input frame 91 to which the current stroke is allocated is the same first input frame 91.

In the process illustrated in FIG. 14, as described hereinafter, until a series of handwritten inputs are started and an overlapping stroke described hereinafter is detected, only allocation to one input frame (first input frame 91) is performed. On the other hand, in the processing illustrated in FIG. 14, as described hereinafter, after occurrence of the overlapping stroke, the allocation process is performed, on the latest two input frames, based on one or more strokes allocated to the two input frames in question.

In step S1400, the input frame allocation processing unit 12 acquires (reads out) the coordinate information of the currently input stroke from the storage unit 41.

In step S1402, based on the coordinate information of the currently input stroke obtained in step S1400, the input frame allocation processing unit 12 calculates an index value related to the stroke. The index value indicates to what extent a passage region of the corresponding stroke is included in either the first input frame 91 or the second input frame 92.

The passage region of the stroke is arbitrary as long as it expresses the region through which the stroke passes, and does not necessarily need to precisely match the region through which the stroke passes. For example, the passage region of the stroke may be the region itself through which the stroke passes (a region having a certain width along the stroke), or may be a rectangular area including the region through which the stroke passes. As described hereinafter, the index value related to a certain stroke may include an occupation rate Q1 of the stroke with respect to the first input frame 91 and an occupation rate Q2 of the stroke with respect to the second input frame 92. Alternatively, the index value related to a certain stroke may be the ratio of the occupation rate Q1 and the occupation rate Q2.

Hereinafter, as an example, it is assumed that the index value related to each stroke includes the occupation rate Q1 of the same stroke for the first input frame 91 and the occupation rate Q2 of the same stroke for the second input frame 92. The occupation rate Q1 of the stroke with respect to the first input frame 91 represents a ratio (a ratio related to the area) of a portion of the stroke included in the first input frame 91 to the entire stroke. Similarly, the occupation rate Q2 of the stroke with respect to the second input frame 92 represents a ratio of a portion of the stroke included in the second input frame 92 to the entire stroke. For example, the occupation rate Q1 and the occupation rate Q2 are calculated as follows.
Occupancy Q1=N1/Ntotal
Occupancy Q2=N2/Ntotal

Here, Ntotal is the total number of coordinate values included in the stroke whose occupation rate is to be calculated. N1 is the number of coordinate values located in the area within the first input frame 91 among all the coordinate values relating to the stroke to be calculated. N2 is the number of coordinate values located in the area in the second input frame 92 among all the coordinate values relating to the stroke to be calculated. Note that, as described above, each coordinate value that defines the area of the first input frame 91 and the area of the second input frame 92 is known.

Alternatively, the occupation rate Q1 and the occupation rate Q2 may be calculated as follows.
Occupancy Q1=SS1/Stotal
Occupancy Q2=SS2/Stotal

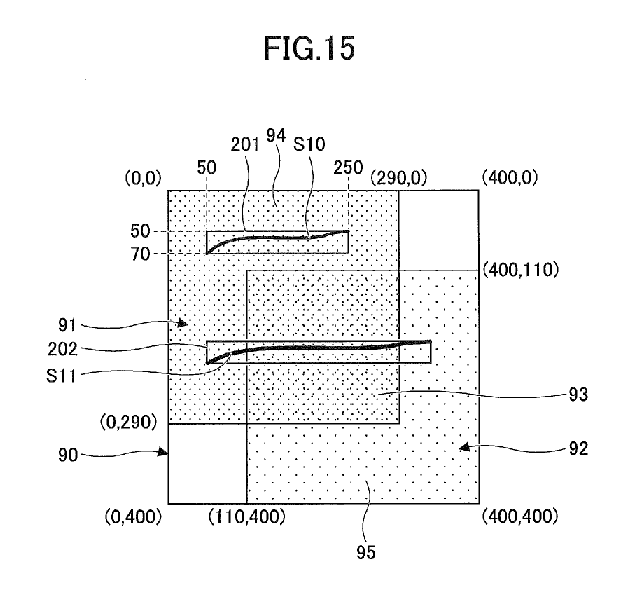

Here, Stotal is the total area of the passage region of the stroke for which the occupation rate is to be calculated. SS1 is an area of a portion, which is included in the first input frame 91, in the same passage region. SS2 is an area of a portion, which is included in the second input frame 92, in the same passage region. For example, the passage region is calculated as the area of the rectangular area including all the coordinate values relating to the stroke to be calculated. In this case, SS1 is the area of the portion, which is included in the first input frame 91, in the rectangular area. SS2 is an area of a portion, which is included in the second input frame 92, in the same passage region. FIG. 15 is an explanatory diagram of a rectangular area. In the example illustrated in FIG. 15, the rectangular area 201 relating to the stroke s10 and the rectangular area 202 related to the stroke sll are illustrated. In the example illustrated in FIG. 15, the input screen 90 having 400×400 coordinate points is illustrated. In the example illustrated in FIG. 15, the maximum value of the x coordinate of the coordinate values of the stroke s10 is “250”, the minimum value of the x coordinate is “50”, the maximum value of the y coordinate is “70”, and the minimum value of the y coordinate is “50”. In this case, as illustrated in FIG. 15, the rectangular area 201 relating to the stroke s10 is surrounded by lines connecting the coordinate values (50, 50), (250, 50), (50, 70) and (250, 70) of the four points.

For example, in the example illustrated in FIG. 15, the occupation rate Q1 relating to the stroke s10 is calculated as 100%, and the occupation rate Q2 related to the stroke s10 is calculated as 0%. Further, in the example illustrated in FIG. 15, the occupation rate Q1 relating to the stroke sll is calculated to be 90%, and the occupation rate Q2 related to the stroke sll is calculated to be 90%.

Note that, in calculating the occupation rate Q1 and the occupation rate Q2, a polygonal region containing the coordinate values relating to all the strokes to be calculated may be used instead of the rectangular area. Further, the rectangular area is not limited to a rectangular area having each side in the horizontal direction and the vertical direction. For example, a rectangular area having sides extending in an oblique direction with respect to the horizontal direction and the vertical direction may be used.

In step S1404, the input frame allocation processing unit 12 determines whether the stroke input this time is an overlapping stroke. The overlapping stroke is a stroke determined to pass through (enter) the overlapped area 93. For example, when the difference between the occupation rate Q1 and the occupation rate Q2 is equal to or less than a predetermined threshold value, the input frame allocation processing unit 12 determines that the stroke input this time is an overlapping stroke. The predetermined threshold value is set to a relatively small value of 0 or more (for example, a value between 0 and 10). In the following description, a stroke that is not an overlapping stroke is also referred to as a “non-overlapping stroke”. If the currently input stroke is determined to be an overlapping stroke, the process goes to step S1410, otherwise, the process goes to step S1406.

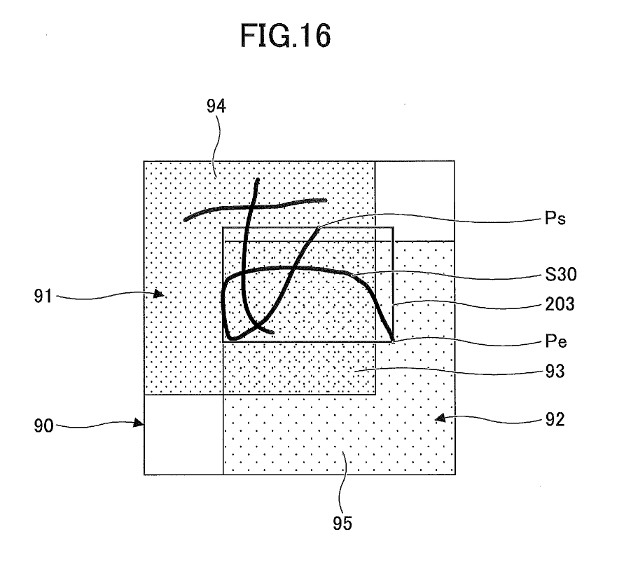

For example, in FIG. 16, a rectangular area 203 according to the third stroke S30 of “ [symbol] ” is illustrated. In the example illustrated in FIG. 16, the occupation rate Q1 and occupation rate Q2 calculated based on the rectangular area 203 are the same at 90%. In this case, the difference between the occupation rate Q1 and occupation rate Q2 is 0, and thus the input frame allocation processing part 12 determines that the stroke S30 is an overlapping stroke.

In step S1406, the input frame allocation processing part 12 allocates the currently input stroke (non-overlapping stroke which is determined to be not an overlapping stroke in step S1404), to the input frame related to the higher of the occupation rate Q1 and the occupation rate Q2. For example, if the occupation rate Q1 is higher than occupation rate Q2, the input frame allocation processing part 12 allocates the currently input stroke to the first input frame 91. On the other hand, if the occupation rate Q2 is higher than occupation rate Q1, the input frame allocation processing part 12 allocates the currently input stroke to the second input frame 92. The allocation of the non-overlapping stroke thus realized is confirmed at this point.

In step S1408, the input frame allocation processing part 12 determines whether there is any overlapping stroke whose overlapping stroke flag is “1”. The overlapping stroke flag is prepared for each overlapping stroke (see step S1410). An initial value of the overlapping stroke flag is “0”. The fact that there is any overlapping stroke whose overlapping stroke flag is “1” represents that there is more than one overlapping stroke before the currently input stroke, and the allocation of the one or more overlapping strokes to the input frame is not confirmed. The fact that there is no overlapping stroke whose overlapping stroke flag is “1” represents that an overlapping stroke prior to the currently input stroke does not exist, or that an overlapping stroke prior to the currently input stroke exists but the allocation of the overlapping stroke has already been confirmed. If there is one or more overlapping stroke flag of “1” present, the process goes to step S1424, otherwise, the process for the currently input stroke ends directly.

In step S1410, the input frame allocation processing part 12 sets the overlapping stroke flag to “1” with respect to the currently input stroke (overlapping stroke). As described above, the overlapping stroke flag is prepared for each overlapping stroke, and is associated with the corresponding one of the overlapping strokes. The overlapping stroke flag associated with a certain overlapping stroke is maintained at “1” until the allocation of the overlapping stroke has been confirmed as described hereinafter.

In step S1412, the input frame allocation processing part 12 derives a single-character candidate or two-character combination candidate (one or more combination candidates), based on the currently input overlapping stroke and one or more strokes which has been input before the currently input overlapping stroke. This is because, at present, the allocation state of one or more strokes, which may be input after the currently input overlapping stroke, cannot be referred, and thus the currently input overlapping stroke cannot be allocated to the first input frame 91 or the second input frame with high precision. When step S1412 is completed, the process goes to step S1416.

In step S1414, the input frame allocation processing part 12 derives a two-character 2n combination candidate (one or more combination candidates), based on the currently input non-overlapping stroke and one or more strokes which have been input before the currently input non-overlapping stroke. In order to derive the two-character combination candidates, the strokes which have been allocated to the input frame (first input frame 91 or the second input frame 92) to which currently input non-overlapping strokes have been allocated, and the strokes which has been allocated to the previous input frame (second input frame 92 or the first input frame 91) are used. That is, the input frame allocation processing part 12 derives the two-character combination candidates, based on one or more strokes allocated to the latest 2 input frames.

The number of the two-character combination candidates which the input frame allocation processing part 12 derives is determined according to the number of overlapping strokes whose overlapping stroke flag is “1”, for example. For example, when the number of the overlapping strokes whose overlapping stroke flag is “1” is “1”, the input frame allocation processing part 12 derives two two-character combination candidates, according to the difference between a case where the overlapping stroke is allocated to the first input frame 91 and a case where the overlapping stroke is allocated to the second input frame 92. In this manner, the input frame allocation processing part 12 derives a plurality of combination candidates, according to the difference between a case where the overlapping stroke, among one or more strokes that have been input before the non-overlapping stroke, is allocated to the first input frame 91 and a case where the overlapping stroke is allocated to the second input frame 92.

Here, one or more strokes that have been input before the currently input non-overlapping stroke include one or more overlapping strokes (“YES” see step S1408). Further, one or more strokes that have been input before the one or more overlapping stroke, and one or more strokes that have been input after the one or more overlapping stroke, are allocated, respectively, to separate input frames of the first input frame 91 and the second input frame 92 (“NO” see step S1424). Therefore, at this time, non-overlapping strokes before and after the one or more overlapping strokes can be determined to be related to handwriting input for two characters with high accuracy. For this reason, in step S1414, as described above, the input frame allocation processing part 12 derives the two-character combination candidates only (i.e., single-character candidate is not derived).

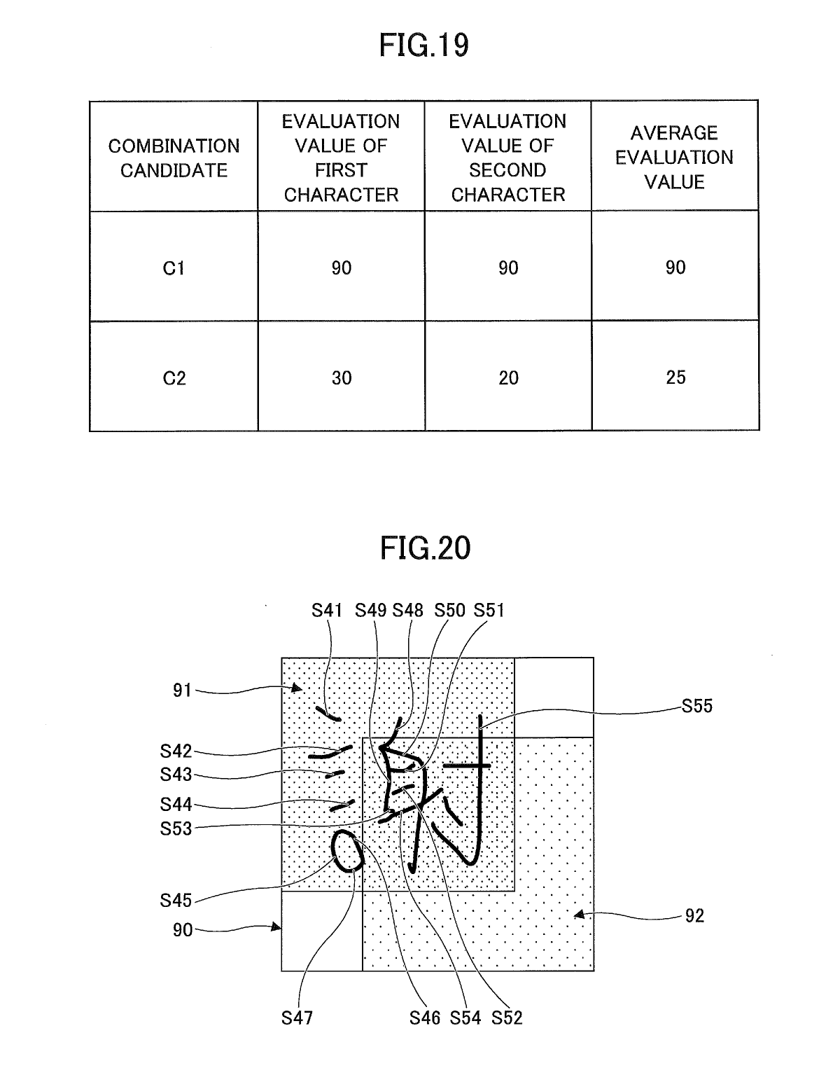

In step S1416, the input frame allocation processing part 12 performs character recognition, with respect to the single-character candidate or two-character combination candidates derived in the step S1412, or with respect to one or more combinations candidate derived in the step S1414. For example, with respect to a certain combination candidate, the input frame allocation processing part 12 recognizes the first character based on one or more strokes related to the first character, and recognizes the second character based on one or more strokes related to the second character. The input frame allocation processing part 12 calculates, based on the recognition result, the evaluation value of each recognized character (see evaluation values in FIG. 19). Note that the process of step S1416 (and the process of subsequent step S1418) may be implemented by the character recognition part 13.

In step S1418, the input frame allocation processing part 12, based on the recognition result in step S1416 (evaluation values for the recognized characters), calculates an average evaluation value per one character (the evaluation value when the recognized character is one character).

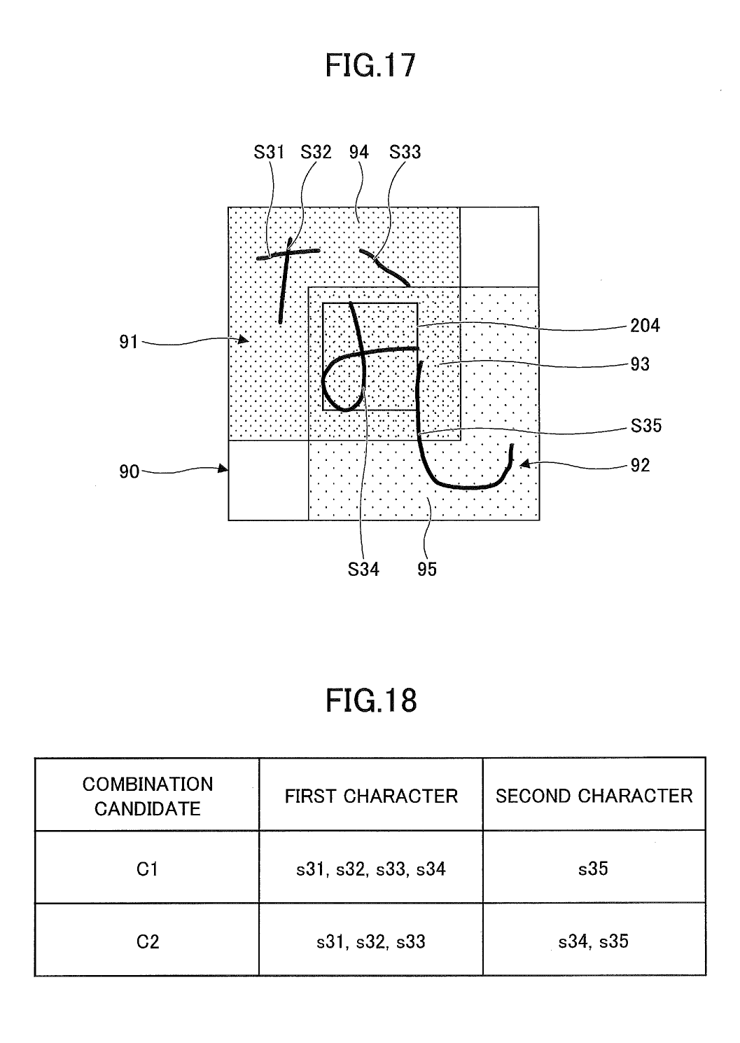

For example, in FIG. 17, an example of each stroke when two characters of “ [symbol] ” and “ [symbol] ” are handwritten is illustrated. “ [symbol] ” is input by handwriting in the first input frame 91, “ [symbol] ” is handwriting input to the second input frame 92. The stroke S31 represents the first stroke of “ [symbol] ”, the stroke S32 represents the second stroke of “ [symbol] ”, the stroke S33 represents the third stroke of “ [symbol] ”, and the stroke S34 represents the fourth stroke of “ [symbol] ”. The stroke S35 represents the stroke of the “ [symbol] ”. In FIG. 17, a rectangular area 204 corresponding to the passage region of the stroke S34 is illustrated. Note that the rectangular area 204 is actually not displayed on the input screen 90 and is illustrated for explanation or reference (this also holds true for other rectangular areas 201 through 203 described above).

In the example illustrated in FIG. 17, the strokes S31 to S33 have the occupation rate Q1 of 100% and the occupation rate Q2 of 0%, and thus the strokes S31 to S33 are allocated to the first input frame 91. Further, the stroke S35 has the occupation rate Q1 of 0% and the occupation rate Q2 of 100%, and thus the stroke S35 is allocated to the second input frame 92. Since the stroke S34 has the occupation rate Q1 of 100% and the occupation rate Q2 of 100%, the stroke S34 is determined to be an overlapping stroke, and thus the overlapping stroke flag is set. In this case, two combination candidates C1 and C2 are derived, depending on a case where the overlapping stroke S34 is allocated to the first input frame 91 and a case where the overlapping stroke S34 is allocated to the second input frame 92, as illustrated in FIG. 18. In FIG. 18, stroke IDs allocated to the combination candidates C1 and C2 are illustrated in a table form. In FIG. 18, stroke IDs of the strokes S31 to S35 are defined as s31 to s35. With respect to the combination candidates C1, the first character is comprised of the strokes S31, S32, S33 and S34, and the second character is comprised of the stroke S35. With respect to the combination candidates C2, the first character is comprised of the strokes S31, S32 and S33, and second character is comprised of the strokes S34 and S35. In this case, as illustrated in FIG. 19, the combination candidate C1 has higher evaluation values of the first character and the second character than the combination candidate C2. For example, in the example illustrated in FIG. 19, in the case of the combination candidates C1, the evaluation values of the first character and second character are respectively “90” and “90”, and thus the average evaluation value is “90”. On the other hand, in the case of the combination candidates C2, the evaluation values of the first character and second character are respectively “30” and “20”, and thus the average evaluation value is “25”.

In step S1420, the input frame allocation processing part 12 performs point addition processing relating to the overlapping stroke, based on at least one of a relationship between a start point coordinate of the overlapping stroke and the first non-overlapped area 94 and a relationship between an end point coordinate of the overlapping stroke and the second non-overlapped area 95. This is because a user who tries to handwrite a character in the first input frame 91 tends to handwrite a stroke starting from the first non-overlapped area 94 as much as possible. Similarly, a user who tries to handwrite a character in the second input frame 92 tends to handwrite a stroke ending in the second non-overlapped area 95 as much as possible.

For example, the input frame allocation processing part 12, if the start point coordinate of the overlapping stroke is located in the first non-overlapped area 94, adds a predetermined value Pt1 (e.g., 10) to the average evaluation value related to the combination candidate for the case of the overlapping stroke being allocated to the first input frame 91. For example, in the example illustrated in FIG. 16, the stroke S30 has the start point coordinate Ps in the first non-overlapped area 94. In this case, the predetermined value Pt1 is added to the average evaluation value of the combination candidate for the case where the stroke S30 is allocated to the first input frame 91. Further, the input frame allocation processing part 12, if the end point coordinate Pe of the overlapping stroke is located in the second non-overlapped area 95, adds a predetermined value Pt2 to the average evaluation value related to the combination candidate for the case of the overlapping stroke being allocated to the second input frame 92. The predetermined value Pt2 may be the same as the predetermined value Pt1, but is set to, for example, a small value (e.g., 5 points). Note that, as is the case with the stroke S30, the stroke whose start point coordinate is located in the first non-overlapped area 94 and whose end point coordinate is located in the second non-overlapped areas 95 may be not applicable for the point addition related to the end point coordinate. This is because, as is the case with the stroke S30 illustrated in FIG. 16, even when trying to handwrite a character in the first input frame 91, there may be a case where the final portion of the stroke enters the second non-overlapped area 95.

In step S1422, the input frame allocation processing part 12 allocates an overlapping stroke to either the first input frame 91 and the second input frame 92, based on the combination candidate whose average evaluation value is the highest. For example, in the example illustrated in FIG. 19, the input frame allocation processing part 12 allocates the overlapping stroke S34 to the first input frame 91 based on the combination candidates C1. Note that, even if the allocation of step S1422 is completed, the overlapping stroke flag is not reset to “0”. That is, the allocation of the overlapping stroke executed in step S1422 is not in a confirmed state but in a temporarily determined state. When step S1422 is completed, the input frame allocation process related to the currently input stroke is completed.

In step S1424, the input frame allocation processing part 12 determines whether the input frame to which the currently input non-overlapping stroke is allocated is the same as the input frame to which the non-overlapping stroke immediately before the one or more overlapping stroke immediately before the currently input non-overlapping stroke is allocated.

For example, in FIG. 20, an example of each stroke when a character of “ [symbol] ” is handwritten is illustrated. In the example illustrated in FIG. 20, the strokes S41 to S47 according to Gonben (radicals) “ [symbol] ” are allocated to the first input frame 91 (step S1406). Further, the stroke S48 related to the first stroke of the center part “ [symbol] ” is allocated to the first input frame 91 (step S1406). The strokes S49 to S54 in the second and subsequent strokes related to “ [symbol] ” are determined to be overlapping strokes (“YES” in step S1404). The stroke S55 related to the first stroke of “ [symbol] ” that is the right part has the occupation rate Q1 greater than the occupation rate Q2 (a difference between the occupation rate Q1 and occupation rate Q2 that is greater than predetermined threshold), and thus stroke S55 is not determined to be an overlapping stroke (“NO” in step S1404). Therefore, the stroke S55 is allocated to the first input frame 91 (step S1406). Further, the non-overlapping stroke S48, which is immediately before the overlapping stroke S49 through S54, which in turn are immediately preceding stroke S55, is allocated to the first input frame 91 which is the same as the input frame to which the stroke S55 is allocated. Therefore, in this case, the determination result in step S1424 becomes “YES”. If the determination result is “YES”, the process goes to step S1426, and if the determination result is “NO”, the process goes to step S1428.

Note that there may be a case where the non-overlapping stroke is not included in one or more of the strokes input before the currently input non-overlapping stroke. That is, there may be a case where one or more of the strokes input before the currently input non-overlapping stroke is consisting of only one or more overlapping strokes. This occurs, for example when the first stroke handwritten in the first input frame 91 is the overlapping stroke. In this case, the input frame allocation processing part 12 may derive one character candidate or two-character combination candidates (one or more combination candidates) in step S1414, as is the case with step S1412.

In step S1426, the input frame allocation processing part 12 allocates one or more overlapping strokes immediately before the currently input non-overlapping stroke, to the input frame to which the currently input non-overlapping stroke has been allocated. Further, the input frame allocation processing part 12 resets the overlapping stroke flag related to one or more overlapping strokes immediately before the currently input non-overlapping stroke to “0”. For example, in the example illustrated in FIG. 20, when the stroke S55 is input, one or more overlapping strokes S49 to S54 immediately before the stroke S55 are allocated to the first input frame 91. Accordingly, the input frame allocation processing part 12 resets the overlapping stroke flags related to the overlapping strokes S49 to S54 to “0”.

In step S1428, the input frame allocation processing part 12 determines whether there is any overlapping stroke allocated to the two-preceding input frame from the input frame to which the currently input non-overlapping stroke is allocated. The two-preceding input frame from the input frame to which the currently input non-overlapping stroke is allocated is the same input frame to which the currently input non-overlapping stroke is allocated.

For example, as described above, there may be a case where a user successively handwrites three characters using the first input frame 91 or the second input frame 92 alternately. In such a case, it is assumed that the overlapping stroke is included in one or more strokes for the handwritten first character, and the overlapping stroke is allocated to the first input frame 91. In this case, when the third character is started to be handwritten from the state where the strokes of the second character are allocated to the second input frame 92, the newly input stroke is allocated to the first input frame 91. In this case, the overlapping stroke of the first character is an overlapping stroke which is allocated to the two-preceding input frame. If the determination result is “YES”, the process goes to step S1430, and if the determination result is “NO”, the process goes to step S1414.

In step S1430, the input frame allocation processing part 12 confirms, based on the input frame allocated to the currently input non-overlapping stroke, the allocation of the overlapping stroke allocated to the two-preceding input frame. That is, the input frame allocation processing part 12, with respect to the overlapping stroke allocated to the two-preceding input frame, confirms the allocation result at the present time that is obtained in step S1422. When the step S1430 is completed, the process goes to step S1414. In this case, the allocation result according to the two-preceding input frame with respect to the currently input frame allocated to non-overlapping strokes has been confirmed, and the allocation with respect to the new last two input frames is started. For example, in the case of the handwriting input being continuously performed for three or more characters alternately to the first input frame 91 and the second input frame 92, when the third character begins to be handwritten to the first input frame 91, the allocation for the overlapping stroke related to the first character is confirmed. Further, when the fourth character begins to be handwritten to the second input frame 92, the allocation for the overlapping stroke related to the second character is confirmed.

As described above, according to the character recognition apparatus 1 according to this embodiment, even in the limited screen size of the apparatus (for example, see FIGS. 2 and 3), a continuous handwriting input for a plurality of characters is possible. Specifically, according to the character recognition apparatus 1, the first input frame 91 and the second input frame 92 have the overlapped area 93. Thus, even when the screen size is relatively small, two input frames can be set, and thus it is possible to implement successive handwriting input for a plurality of characters.

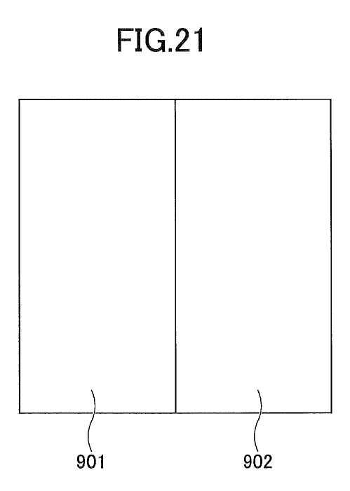

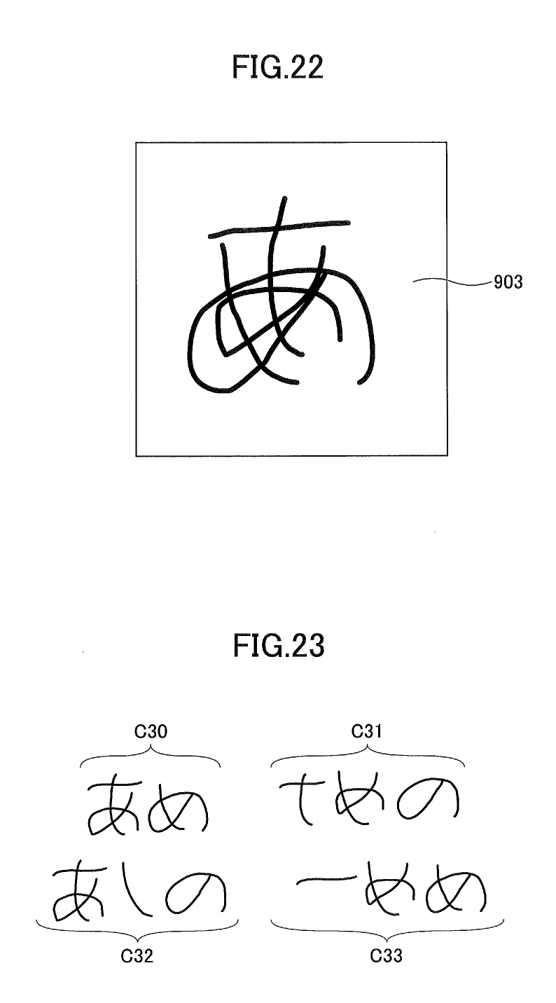

Next, a further effect of the character recognition apparatus 1 according to this embodiment will be described, comparing with a comparative example illustrated in FIGS. 21 and 22.

FIG. 21 is a diagram illustrating an input screen according to the first comparative example.

The screen size of the input screen according to the first comparative example is assumed to be the same as the input screen 90 of the character recognition apparatus 1. In the first comparative example, two input frames 901 and 902 are set such that the input screen is divided in two for the left and right sides. Note that the input frames 901 and 902 do not have an overlapped area.

According to such a first comparative example, it is possible to implement successive handwriting input for a plurality of characters. However, in the first comparative example, as illustrated in FIG. 21, sizes of the input frame 901 and 902 are limited due to the limited size of the input screen. In the example illustrated in FIG. 21, the input frames 901 and 902, respectively, have insufficient lengths in the horizontal direction, which induces difficulties at the time of handwriting characters with a relatively great lateral width (or, recognition accuracy tends to be reduced due to strokes extending outside the input frames in the horizontal direction).

In contrast, according to the character recognition apparatus 1 according to this embodiment, the first input frame 91 and the second input frame 92 have the overlapped area 93. Thus, even when the screen size is relatively small, the first input frame 91 and the second input frame 92 can be set to an appropriate size, which can reduce or eliminate the inconvenience that occurs in the first comparative example.

FIG. 22 is a diagram illustrating an input screen according to a second comparative example. The screen size of the input screen according to the second comparative example is assumed to be the same as the input screen 90 of the character recognition apparatus 1. In the second comparative example, the input frame 903 for one character is set to the entire input screen. In FIG. 22, each stroke when two characters “ [symbol] ” and “ [symbol] ” are handwritten such that they are overwritten is illustrated. In this case, for example, as illustrated in FIG. 23, for example, four combination candidates C30 to C33 can be derived. In this case, the difference in the average evaluation value between the combination candidate C30 and the combination candidate C32 is not significant. Thus, in the second comparative example, inconvenience in terms of recognition accuracy occurs.

In contrast, according to the character recognition apparatus 1 according to this embodiment, it is possible to reduce or eliminate the inconvenience caused by the second comparative example. For example, in the example illustrated in

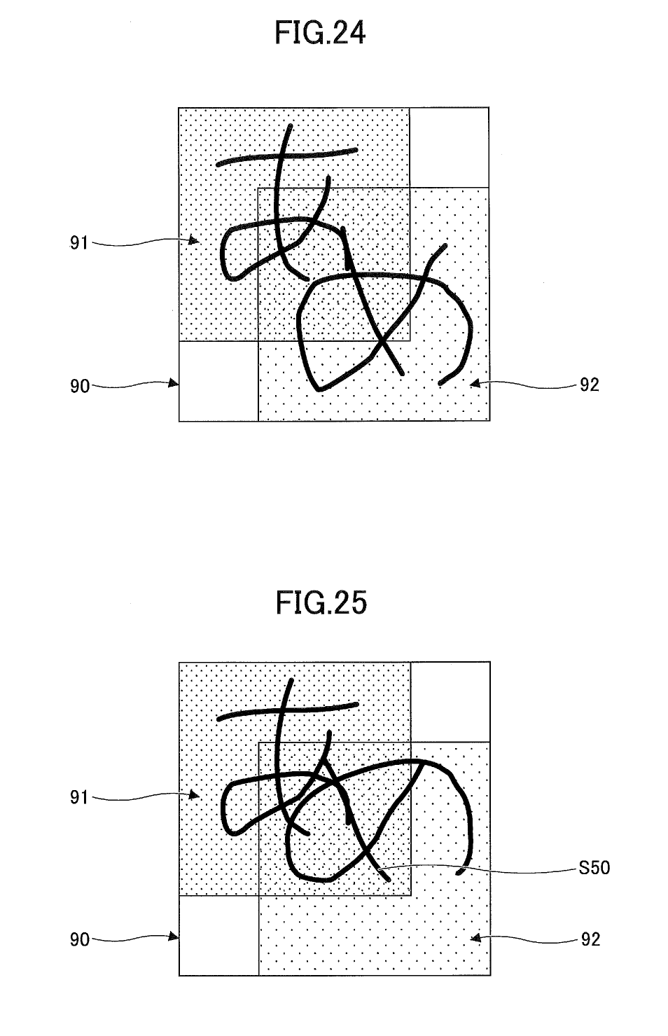

FIG. 24, an example of each stroke is illustrated when the user, with respect to two characters “ [symbol] ” and “ [symbol] ”, handwrites “ [symbol] ” to the first input frame 91 and handwrites “ [symbol] ” to the second input frame 92. In this case, since the number of characters being two can be confirmed when the first stroke of “ [symbol] ” is allocated to the second input frame 92, it is sufficient to generate only combination candidates for two characters. Further, in the example illustrated in FIG. 24, since an overlapping stroke does not occur, the combination candidate becomes only one when the last stroke of “ [symbol] ” has been input. In this case, without the need for character recognition, it is possible to perform the allocation of each stroke. Thus, according to the character recognition apparatus 1 according to this embodiment, a shift in a position between one or more strokes related to the first character and one or more strokes related to the second character handwritten to the first input frame 91 and the second input frame 92 is used to improve the character recognition accuracy. Note that, according to the character recognition apparatus 1 according to this embodiment, it is easy for a user to handwrite two characters in a shifted relationship, by utilizing the first input frame 91 and the second input frame 92 as a guide.

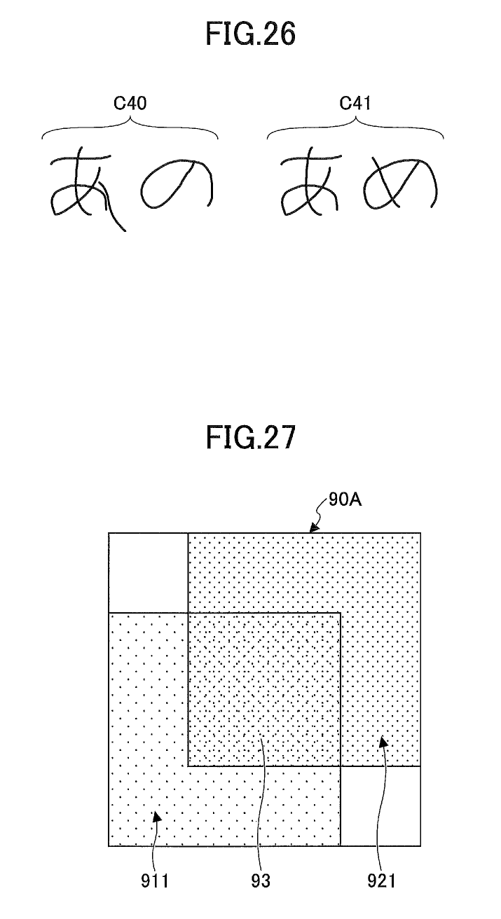

In the example illustrated in FIG. 25, an example of each stroke is illustrated when the user, with respect to two characters “ [symbol] ” and “ [symbol] ” handwrites “ [symbol] ” to the first input frame 91 and handwrites “ [symbol] ” to the second input frame 92. However, in the example illustrated in FIG. 25, as compared with the example illustrated in FIG. 24, each stroke of the character “ [symbol] ” is handwritten to the second input frame 92 such that each stroke is offset on the upper left side of the second input frame 92. In this case, since the stroke S50 is determined as an overlapping stroke, two combination candidates C40 and C41 are derived according to the way of the allocation of the overlapping stroke S50, as illustrated in FIG. 26. Even in such a case, according to this embodiment, as compared to the second comparative example, the number of combination candidates is reduced, and thus the processing load is reduced while increasing the recognition accuracy. That is, in the second comparative example, since the number of input characters cannot be determined based on the strokes, as illustrated in FIG. 23, the candidate combination C31 to C33 for 3 characters may be derived. In this case, according to the embodiment, since the number of characters being two can be confirmed when the last stroke of “ [symbol] ” is allocated to the second input frame 92, it is sufficient to generate only combination candidates for two characters. Therefore, according to this embodiment, it is possible to narrow the combination candidates as compared to the second comparative example, and thus the processing load is reduced while increasing the recognition accuracy.

Further, in the example illustrated in FIG. 26, unlike the example illustrated in FIG. 22, each stroke of the character “ [symbol] ” does not completely overlap with each stroke of the character “ [symbol] ”, and thus there is still a positional shift. Therefore, according to the present embodiment, the difference in the average evaluation value between two or more derived combination candidates is likely to occur due to such a positional shift, so that the recognition accuracy is improved. For example, in the example illustrated in FIG. 26, the evaluation value of the first character of the combination candidate C40 is low (because the first character includes the first stroke of “ [symbol] ”). Therefore, the average evaluation value of the combination candidate C41 becomes significantly greater than the average evaluation value of the combination candidate C40. As a result, allocation is performed based on the combination candidate C41, and thus an accurate recognition result can be obtained.

Further, also in the second comparative example illustrated in FIG. 22, it is possible to increase the recognition accuracy by having the user perform continuous handwriting input of a plurality of characters while leaving a waiting time for each character. For example, in the example illustrated in FIG. 22, when the user starts to handwrite strokes of the character “ [symbol] ” by leaving a waiting time after handwriting strokes of the character “ [symbol] ”, the waiting time is used to detect a delimiter between these characters, which can improve the recognition accuracy. However, with such a configuration, due to the waiting time, the time required for consecutive handwriting input of a plurality of characters becomes long.

In this regard, according to the character recognition apparatus 1 of this embodiment, since the first input frame 91 and the second input frame 92 have the overlapped area 93, necessity for the user to leave a waiting time between each character is reduced or eliminated. As a result, it is possible for the user to shorten the time required for consecutive handwriting input of a plurality of characters. For example, in the example illustrated in FIG. 7, the user can handwrite without leaving a waiting time between the characters “ [symbol] ” and “ [symbol] ”. However, even when the first input frame 91 and the second input frame 92 have the overlapped area 93 set therein, the user may be enabled to leave a waiting time before starting to handwrite to the second input frame 92 and after having handwritten to the first input frame 91. In this case, also in the character recognition apparatus 1 according to the present embodiment, recognition accuracy can be further improved by detecting such a waiting time.

According to the character recognition apparatus 1 of the present embodiment, as described above, the first input frame 91 and the second input frame 92 have the overlapped area 93. Therefore, overlapping strokes are generated depending on the way of handwriting by the user. The allocation accuracy in allocating such overlapping strokes to one of the first input frame 91 and the second input frame 92 is important in order to further improve recognition accuracy. Note that the allocation accuracy can also be said to be the discrimination accuracy in discriminating to which of the input frames the overlapping stroke is intended, that is, whether the first input frame 91 or the second input frame 92. Hereinafter, “allocation accuracy” is referred to as “discrimination accuracy”.

In this regard, according to the character recognition apparatus 1 of this embodiment, in determining whether the overlapping stroke is to be allocated to the first input frame 91 or the second input frame 92, the allocation state of the strokes before or after the overlapping stroke is referred to. For example, in the example illustrated in FIG. 14, in steps S1414 to S1418 and S1422, the overlapping stroke is allocated to the first input frame 91 or the second input frame 92, based on the combination candidates determined according to the allocation states of strokes before and after the overlapping stroke. This makes it possible to use the evaluation values of the combination candidates including the strokes before and after the overlapping stroke, so that the discrimination accuracy can be further increased. Also, in the example illustrated in FIG. 14, in steps S1424 and S1426, the overlapping stroke is allocated to the same input frame as the input frames allocated to the respective non-overlapping strokes before and after the overlapping stroke. As a result, for example, in addition to “ [symbol] ” as illustrated in FIG. 20, even when characters having the radicals of “ [symbol] ” and “ [symbol] ” are input by handwriting, the discrimination accuracy can be further enhanced.

Further, according to the character recognition apparatus 1 of this embodiment, in determining whether the overlapping stroke is to be allocated to the first input frame 91 or the second input frame 92, the start point coordinate and the end point coordinate of the overlapping stroke are utilized (step S1420). In this way, since the user's tendency (the above-described tendency) at the time of handwriting the overlapping stroke can be used, the discrimination accuracy can be further increased.

Further, according to the character recognition apparatus 1 of the present embodiment, based on the index value indicating the extent to which the passage region of the stroke is included in either the first input frame 91 or the second input frame 92, it is determined whether the stroke is an overlapping stroke. As a result, it is possible to regard only such a stroke, to which it is impossible or difficult to determine which of the first input frame 91 and the second input frame 92 is to be allocated based on the position of the passage region thereof, as an overlapping strokes. In this respect, for example, such a comparative example can be contemplated in which whether a stroke is an overlapping stroke is determined based on only whether or not the passage region of the stroke is included in the overlapped area 93. In this comparative example, for example, in the case of the example illustrated in FIG. 24, since the passage regions of the first stroke of “ [symbol] ” and the second stroke of “ [symbol] ” are included in the overlapped area 93, respectively, it is determined that these strokes are overlapping strokes. In this case, the number of overlapping strokes increases, and the number of combination candidates increases accordingly, which is disadvantageous from the viewpoint of processing load and discrimination accuracy. On the other hand, according to the character recognition apparatus 1 of the present embodiment, it is possible to accurately determine only the strokes, which require reference of the allocation state of the preceding and succeeding strokes, as the overlapping strokes, based on the index value described above. As a result, a probability that even a stroke, which is unnecessary to refer to the allocation state of strokes before and after the stroke, is regarded as an overlapping stroke is reduced or eliminated, so that the discrimination accuracy can be further increased.

### [Variation]

Next, variants of an input frame that can be used in place of the first input frame 91 and the second input frame 92 in the above-described embodiment will be described. In the following drawings, the same elements are denoted by the same reference numerals, and description thereof is omitted.

FIG. 27 is an explanatory diagram of an input frame according to a first variant.

In the first variant, a first input frame 911 and a second input frame 921 are displayed on the input screen 90A. The screen size of the input screen 90A is the same as the input screen 90. Similarly, the first input frame 911 and the second input frame 921 have an overlapped area 93. Like the first input frame 91 and the second input frame 92, the first input frame 911 and the second input frame 921 are shifted with respect to each other in either of the vertical direction (y direction) and the horizontal direction (x direction) of the input screen 90. The first input frame 911 and the second input frame 921 differ from the first input frame 91 and the second input frame 92 according to the above-described embodiment in positions in the vertical direction. Specifically, the first input frame 911 is arranged at the left and the lower corner of the input screen 90A and the second input frame 921 is arranged at the upper and right side and the upper side of the input screen 90A, and the right and the upper side of the first input frame 911 is overlapped with the left and lower corner of the second input frame 921.

According to the first variant, the same effects as the embodiment described above can be obtained. Further, according to the first variant, due to the arrangement of the first input frame 911 and the second input frame 921, the following advantageous effects can be obtained. Even when a character having Kanji radicals such as “ [symbol] ”, “ [symbol] ”, “ [symbol] ”, “ [symbol] ”, etc., is handwritten, the strokes thereof are likely to extend beyond the overlapped area 93 (for example, the strokes S48 and S55 in FIG. 20), which increases the discrimination accuracy. Note that such advantages are also the same for the first input frame 91 and the second input frame 92 according to the above-described embodiment.

Note that the same applies to the following variants, but handwriting input is also possible with respect to an area excluding the first input frame 911 and the second input frame 921 from the entire area of the input screen 90A, as described above. Therefore, the stroke entering such a area is also used for character recognition.

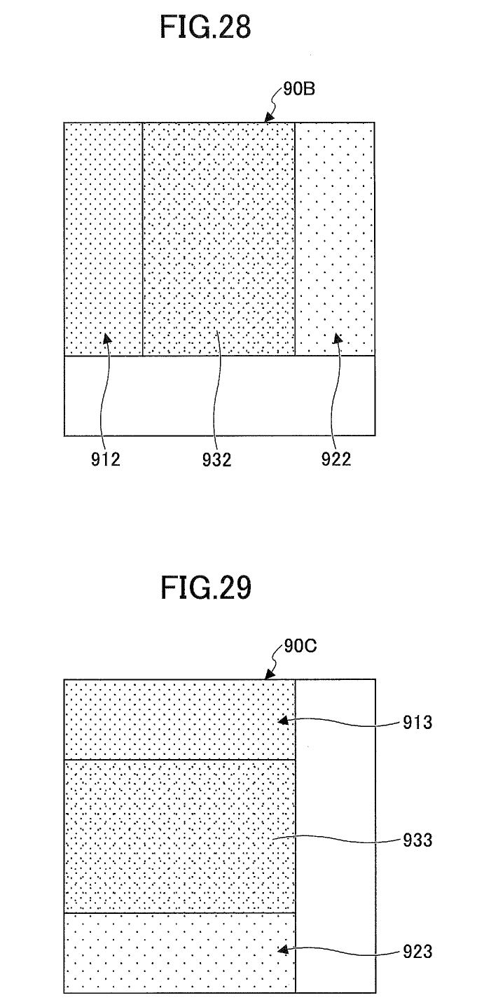

FIG. 28 is an explanatory diagram of an input frame according to a second variant.

In the second variant, a first input frame 912 and a second input frame 922 are displayed on the input screen 90B. The screen size of the input screen 90B is the same as the input screen 90.

Similarly, the first input frame 912 and the second input frame 922 have an overlapped area 932. The first input frame 912 and the second input frame 922 are shifted with respect to each other only in the horizontal direction (x direction) of the input screen 90B. The first input frame 912 is arranged on the left and upper side corner of the input screen 90B and the second input frame 922 is arranged on the right and upper corner of the input screen 90B.

According to the second variant, the same effects as the embodiment described above can be obtained because of the overlapped area 932. Further, according to the second variant, a laterally long area can be used due to the arrangement of the first input frame 912 and the second input frame 922.

FIG. 29 is an explanatory diagram of an input frame according to a third variant.

In the third variant, a first input frame 913 and a second input frame 921 are displayed on an input screen 90C. The screen size of the input screen 90C is the same as the input screen 90. Similarly, the first input frame 913 and the second input frame 923 have an overlapped area 933. The first input frame 913 and the second input frame 923 are shifted only in the vertical direction (y direction) of the input screen 90C. The first input frame 913 is arranged at the left and upper corner of the input screen 90C and the second input frame 923 is arranged at the left and lower corner of the input screen 90C.

According to the third variant, the same effects as the embodiment described above can be obtained because of the overlapped area 933. Further, according to the third variant, it is possible to use a vertically long area due to the arrangement of the first input frame 913 and the second input frame 923.

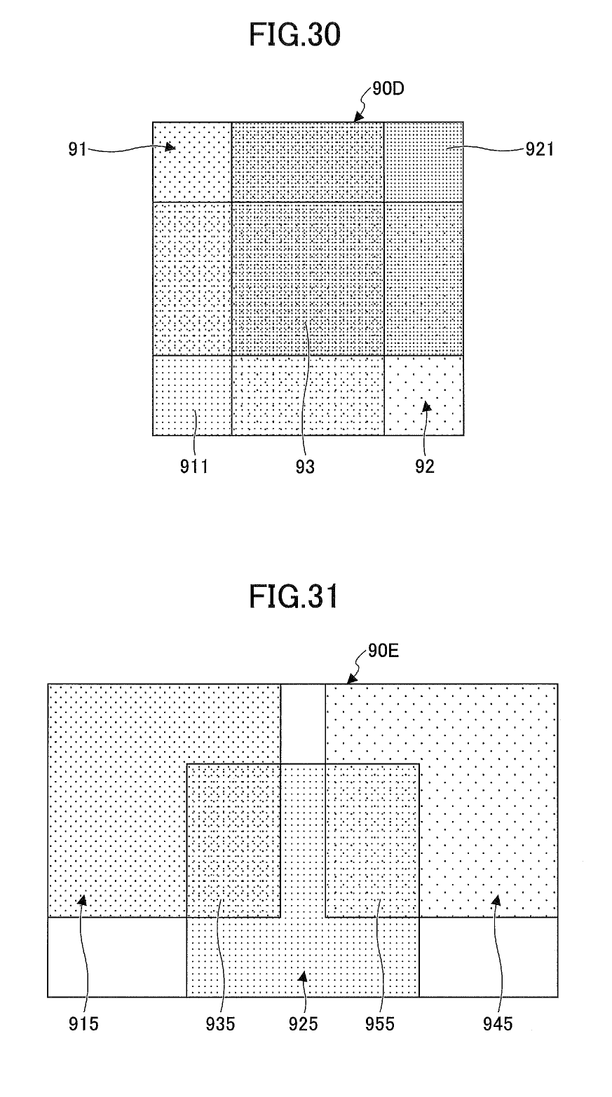

FIG. 30 is an explanatory diagram of an input frame according to a fourth variant.

In the fourth variant, four input frames are displayed on an input screen 90D. Specifically, the first input frame 91 and the second input frame 92, and the first input frame 911 and the second input frame 921 are displayed on the input screen 90D. The screen size of the input screen 90D is the same as the input screen 90. The arrangement of the first input frame 91 and the second input frame 92 is as described above (refer to the above-mentioned embodiment), and the first input frame 911 and the second input frame 921 are as described above (refer to the first variant).

According to the fourth variant, the same effects as the embodiment described above can be obtained because of the overlapped area 93. Further, according to the fourth variant, since the number of input frames is greater than in the above-described embodiment, the user can handwrite by merely shifting a plurality of characters little by little. In this way, the number of input frames is not limited to two, and may be an arbitrary number of three or more.

FIG. 31 is an explanatory diagram of an input frame according to a fifth variant.

In the fifth variant, three input frames are displayed on an input screen 90E. Specifically, a first input frame 915, a second input frame 925, and a third input frame 945 are displayed on an input screen 90E. Unlike the screen shape (square) of the input screen 90, the screen shape of the input screen 90E is horizontally long. The first input frame 915 and the second input frame 925 include an overlapped area 935, and the second input frame 925 and the third input frame 945 include an overlapped area 955. Note that the first input frame 915 and the third input frame 945 do not have any overlapped area. The first input frame 915 and the second input frame 925 are shifted with respect to each other in both the vertical direction (y direction) and the horizontal direction (x direction) of the input screen 90E. In addition, the second input frame 925 and the third input frame 945 are shifted with respect to each other in both the vertical direction (y direction) and the horizontal direction (x direction) of the input screen 90E.

According to the fifth variant, the same effects as the embodiment described above can be obtained because of the overlapped areas 935 and 955. According to the fifth variant, by utilizing the shape of the input screen 90E, a laterally long area can be used while shifting two neighboring input frames in both the vertical direction (y direction) and the horizontal direction (x direction).

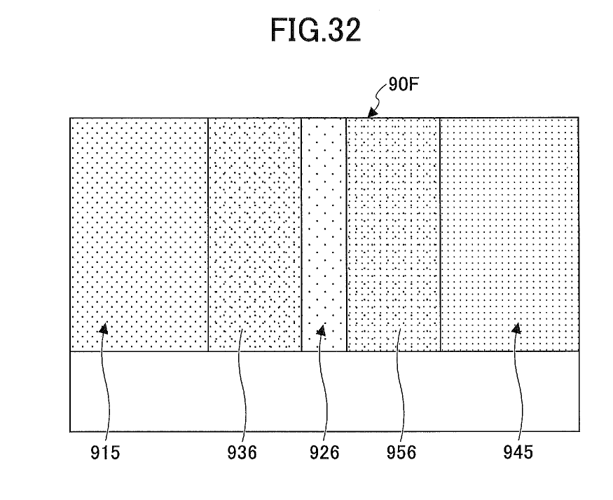

FIG. 32 is an explanatory diagram of an input frame according to a sixth variant.

In the sixth variant, three input frames are displayed on an input screen 90F. Specifically, a first input frame 915, a second input frame 926, and a third input frame 945 are displayed on an input screen 90F. Unlike the screen shape (square) of the input screen 90, the screen shape of the input screen 90F is horizontally long. The first input frame 915 and the second input frame 926 include an overlapped area 936, and the second input frame 926 and the third input frame 945 include an overlapped area 956. The first input frame 915 and the second input frame 926 are shifted with respect to each other only in the horizontal direction (x direction) of the input screen 90F. Further, the second input frame 926 and the third input frame 945 are shifted with respect to each other only in the horizontal direction (x direction) of the input screen 90F.

According to the sixth variant, the same effects as the embodiment described above can be obtained because of the overlapped areas 936 and 956. According to the sixth variant, by utilizing the shape of the input screen 90F, a laterally long area can be used while shifting two neighboring input frames in the horizontal direction (x direction).

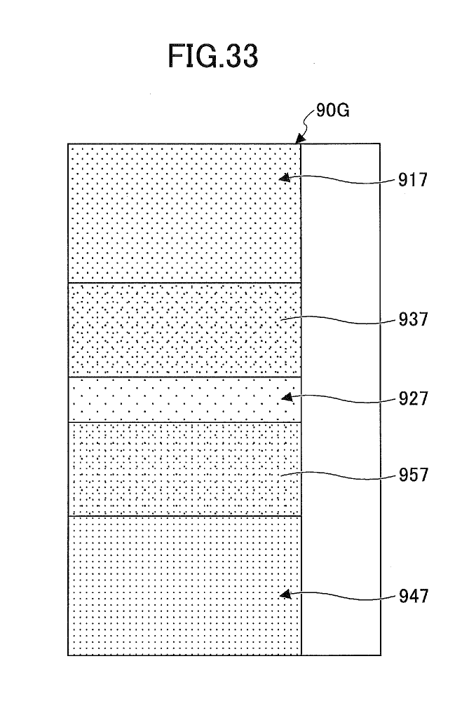

FIG. 33 is an explanatory diagram of an input frame according to a seventh variant.

In the seventh variant, three input frames are displayed on an input screen 90G. Specifically, a first input frame 917, a second input frame 927, and a third input frame 947 are displayed on an input screen 90G. Unlike the screen shape (square) of the input screen 90, the screen shape of the input screen 90G is vertically long. The first input frame 917 and the second input frame 927 include an overlapped area 937, and the second input frame 927 and the third input frame 947 include an overlapped area 957. The first input frame 917 and the second input frame 927 are shifted with respect to each other only in the vertical direction (y direction) of the input screen 90G. Further, the second input frame 927 and the third input frame 947 are shifted with respect to each other only in the vertical direction (y direction) of the input screen 90G.

According to the seventh variant, the same effects as the embodiment described above can be obtained because of the overlapped areas 937 and 957. According to the seventh variant, by utilizing the shape of the input screen 90G, a vertically long area can be used while shifting two neighboring input frames in the vertical direction (y-direction). Note that also in the seventh variant, as in the fifth variant illustrated in FIG. 31, the first input frame 917 and the second input frame 927 may be shifted with respect to each other in the vertical direction (y direction) and the horizontal direction (x-direction) of the input screen 90G. Similarly, the second input frame 927 and the third input frame 947 may be shifted with respect to each other in the vertical direction (y direction) and the horizontal direction (x-direction) of the input screen 90G.

### [Applications]

Next, an example of how to use the character recognition apparatus 1 (applications) is schematically described.

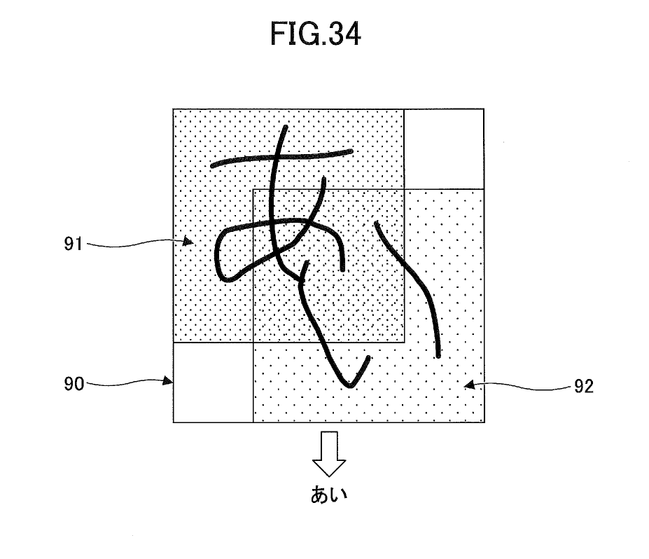

FIG. 34 is a diagram explaining a first application.

In the first application, as in the embodiment described above, as illustrated conceptually in FIG. 34, strokes input by handwriting to the first input frame 91 and the second input frame 92 are subject to the character recognition, and the recognized characters are displayed as they are. For example, in the example illustrated in FIG. 34, “ [symbol] ” and “ [symbol] ” are handwritten, and thus characters “ [symbol] ” and “ [symbol] ” are displayed. Note that the recognized characters are not required to be displayed, or in addition to being displayed, may be output in other ways. For example, the recognized characters may be output by voice.

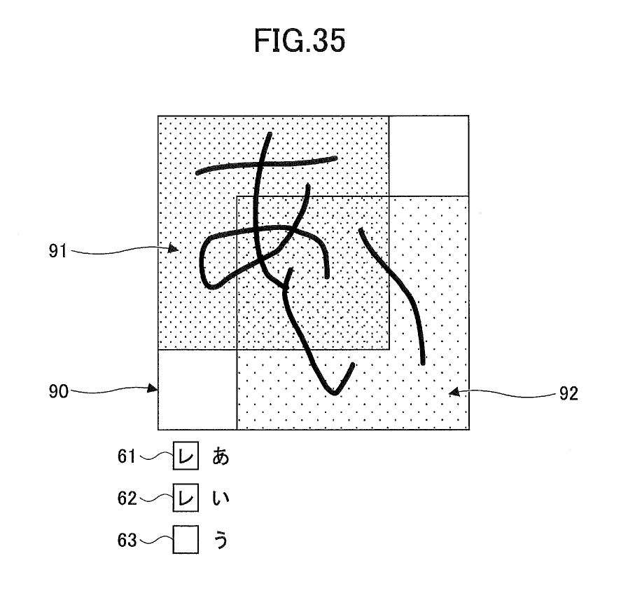

FIG. 35 is a diagram explaining a second application.

In the second application, as illustrated conceptually in FIG. 35, strokes input by handwriting to the first input frame 91 and the second input frame 92 are subject to the character recognition, and check boxes 61 corresponding to the recognized characters are ticked with a check mark. Thus, the character recognition apparatus 1 can be used in applications for selecting one or ones of a plurality of items.

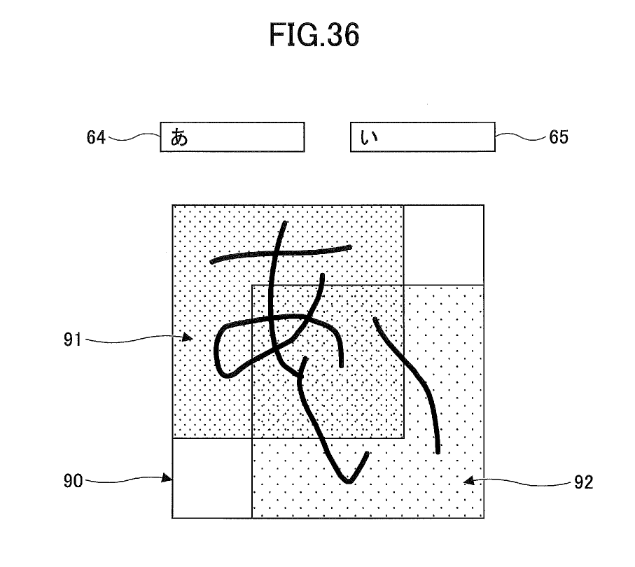

FIG. 36 is a diagram explaining a third application.

In a third application, as illustrated conceptually in FIG. 36, strokes input by handwriting to the first input frame 91 and the second input frame 92 are subject to the character recognition. The recognized characters are displayed (input) in input fields 64 and 65 respectively associated with the first input frame 91 and the second input frame 92. In the example illustrated in FIG. 36, the first input frame 91 is associated with the first input field 64, and the second input frame 92 is associated with the second input field 65. Thus, the character recognition apparatus 1 may be used in applications for input to the segmented input fields (input areas).

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention. Further, all or part of the components of the embodiments described above can be combined.

For example, the outer shape and/or size of the first input frame 91 and the second input frame 92 is optional. In the example illustrated in FIG. 6, the first input frame 91 and the second input frame 92 each are squares; however, for example, depending on the screen shape, etc. of the input screen 90, for example, other shapes, such as a rectangular, polygonal, circular or elliptical shape, etc., may be used. Further, in the example illustrated in FIG. 6, the first input frame 91 and the second input frame 92 have the same size; however, the first input frame 91 and the second input frame 92 may be different in size. These modifications hold true for other variants such as the first variant, etc., described above.

Similarly, the outer shape and/or size of the overlapped area 93 is selectable. The proportion of the overlapped area 93 occupied by the first input frame 91 (and the proportion of the overlapped area 93 occupied by the second input frame 92) is selectable also. However, preferably, the width of the overlapped area 93 is greater than the half the width of the first input frame 91 (or the second input frame 92, hereinafter the same). Also, preferably, the height of the overlapped area 93 is greater than half of the height of the first input frame 91. Also, preferably, the area of the overlapped area 93 is greater than one quarter of the area of the first input frame 91. In such a case, the discrimination accuracy described above is improved. These modifications hold true for other variants such as the first variant, etc., described above.

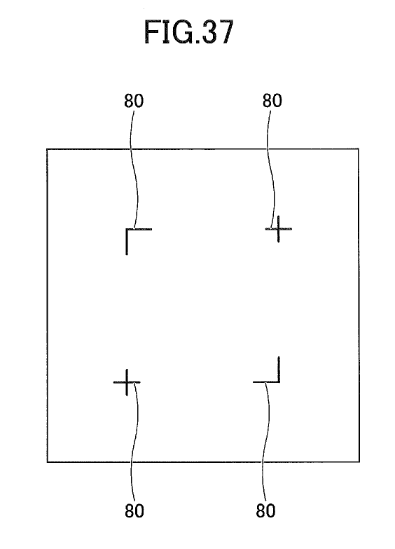

Further, the first input frame 91 and the second input frame 92 are not required to be entirely displayed as a frame such that the first input frame 91 and the second input frame 92 may be partially displayed. For example, the first input frame 91 and the second input frame 92 may be displayed with a dotted line or only corner portions thereof may be displayed. Further, the first input frame 91 and the second input frame 92 are not required to be displayed as an image on the display operation device 101. For example, the first input frame 91 and the second input frame 92 may be replaced with images that visually suggest at least a part of a boundary between a first input area related to the first input frame 91 and a second input area related to the second input frame 92. For example, the boundary between the first input area and the second input area may be suggested by frame lines (physical lines), irregularities, patterns, etc., formed on the screen itself of the display operation device 101, or may be suggested by frame lines (physical lines), irregularities, patterns, etc., rendered on a screen protective seal to be adhered to the screen of the display operation device 101. Further, for example, as illustrated in FIG. 37, the first input area related to the first input frame 91 and the second input area related to the second input frame 92 may be suggested by an image 80 such as +marks or patterns or the like arranged on the boundary therebetween. These modifications hold true for other variants such as the first variant, etc., described above.

Further, in the process illustrated in FIG. 14, various modifications and changes are possible. For example, the process of step S1422 may be omitted.

Further, in the process illustrated in FIG. 14, as described above, the input frame allocation process for each last two input frames are performed; however, the input frame allocation process may be performed for each latest pair of the first input frame 91 and the second input frame 92. For example, strokes input by a series of handwriting input is assumed to include strokes Sa1 through San related to the first two characters and strokes Sb2 through Sbm related to the next two characters. In this case, in a situation where the strokes for Sa1 through San are allocated to the first input frame 91 and the second input frame 92, the switching of the pair may be realized in response to a new stroke Sb1 being input and allocated to the first input frame 91. That is, when the stroke Sb1 is allocated to the first input frame 91, the allocation result of the overlapping stroke(s) among the stroke Sa1 through San at that time is confirmed. The allocation of the stroke Sb1 and subsequent strokes Sb2 through Sbm is performed similarly, but in an independent manner from the allocation result of the stroke Sa1 through San, with respect to a new pair of the first input frame 91 and the second input frame 92. Specifically, in the process illustrated in FIG. 14, the following modifications may be implemented. In step S1430, the input frame allocation processing part 12 confirms the allocation of all the overlapping strokes whose overlapping stroke flag is “1” at this time, and resets all the overlapping stroke flags to “0”. Then, when the step S1430 is completed, the process for the currently input stroke is immediately terminated.

Further, in the above-described embodiment, the first input frame 91 and the second input frame 92 are not changed according to character attributes to be handwritten (e.g., alphabets, Chinese characters, hiragana, etc.,); however, this is not indispensable. For example, if the attribute of the character to be handwritten is known in advance, the size of the first input frame 91 and the second input frame 92 may be changed according to the attribute. For example, in the case of an input field for an e-mail address, the attribute of the character to be handwritten thereto is alphabets or numerals. Therefore, in such a case, the sizes of the first input frame 91 and the second input frame 92 may be changed such that the area of the overlapped area 93 is reduced. This is because, in the case of alphabetic letters or numerals, as compared with the Hiragana and Chinese characters, etc., there is a high possibility that all strokes become overlapping strokes if the area of the overlapped area 93 is relatively great.

What is claimed is:

1. A method of recognizing characters, the method comprising:
displaying, on a screen on which a handwriting input can be accepted, an image that suggests a first input area and a second input area, the first input area and the second input area being partly overlapped; and
recognizing a handwritten input in the first input area and a handwritten input in the second input area as different characters.

2. A method of recognizing characters, the method comprising:
receiving a plurality of handwritten strokes on a screen, the screen having a first input area and a second input area, the first input area and the second input area being partly overlapped; and
allocating the handwritten strokes to either of the first input area or the second input area to recognize first and second characters.

3. The method of claim 1, wherein a width of an overlapped area between the first input area and the second input area is greater than a half of a width of the first input area.

4. The method of claim 1, wherein a height of an overlapped area between the first input area and the second input area is greater than a half of a height of the first input area.

5. The method of claim 1, wherein an area of an overlapped area between the first input area and the second input area is greater than a quarter of an area of the first input area.

6. The method of claim 1, wherein the first input area and the second input area are offset in each of vertical and horizontal directions of the screen.

7. The method of claim 1, wherein when allocating an overlapped area entering stroke of the handwritten strokes, which enters the overlapped area between the first input area and the second input area, to either of the first input area or the second input area, coordinate information of the overlapped area entering stroke and an allocation state of prior and subsequent strokes to the first or second input area are referred to, the prior and subsequent strokes having been input prior to and subsequent to the overlapped area entering stroke.

8. The method of claim 7, wherein when allocating the overlapped area entering stroke, which enters the overlapped area between the first input area and the second input area, to either of the first input area or the second input area, at least one of a start point coordinate and an end point coordinate of the overlapped area entering stroke is used.

9. The method of claim 7, wherein when allocating each of the strokes, passage region information of a passage region which the stroke has entered is used, the passage region information being based on the coordinate information of said stroke.

10. The method of claim 9, wherein the passage region information includes information of a rectangular area, the rectangular area including an area which the stroke has entered.

11. The method of claim 9, wherein using the passage region information includes calculating an index value that represents how much the passage region is included in the first input area and how much the passage region is included in the second input area.

12. The method of claim 11, wherein the index value includes a first ratio and a second ratio, the first ratio being between the total passage region and a part of the passage region included in the first input area, and the second ratio being between the total passage region and a part of the passage region included in the second input area.

13. The method of claim 12, wherein using the passage region information further includes determining, based on the first ratio and the second ratio, for each of the strokes, whether the stroke has entered the overlapped area between the first input area and the second input area.

14. The method of claim 13, wherein when a difference between the first ratio and the second ratio with respect to a certain stroke is less than or equal to a predetermined threshold, the certain stroke is determined as an overlapped area entering stroke that has entered the overlapped area.

15. The method of claim 7, wherein allocating the overlapped area entering stroke further includes allocating the overlapped area entering stroke to the first input area when the prior and subsequent strokes have been allocated to the first input area, and allocating the overlapped area entering stroke to the second input area when the prior and subsequent strokes have been allocated to the second input area.

16. The method of claim 15, wherein allocating the overlapped area entering stroke further includes
generating, based on the strokes, a plurality of candidates of a combination of one or more strokes representing a first character and one or more strokes representing a second character;
calculating, on a generated candidate basis, a score that represents a likelihood of a character recognized based on the candidate, and
allocating the overlapped area entering stroke to either of the first input area or the second input area based on the candidate with the highest calculated score.

17. The method of claim 16, wherein calculating the score includes calculating the score such that the score becomes higher in the case of the start point coordinate or the end point coordinate of the overlapped area entering stroke existing in an area of the first or second input area other than the overlapped area than in the case of the start point coordinate or the end point coordinate of the overlapped area entering stroke not existing in said area.

18. The method of claim 8, wherein a probability of the overlapped area entering stroke being allocated to the input area, in which the start point coordinate or the end point coordinate of the overlapped area entering stroke exists, is higher in the case of the start point coordinate or the end point coordinate of the overlapped area entering stroke existing in an area of the first or second input area other than the overlapped area than in the case of the start point coordinate or the end point coordinate of the overlapped area entering stroke not existing in said area.

19. The method of claim 1, wherein the handwritten input includes a stylus input.

20. A character recognition apparatus, comprising:
a member or a processor that provides, on a screen on which a handwriting input can be accepted, an image that suggests a first input area and a second input area, the first input area and the second input area being partly overlapped; and
a processor configured to recognize a handwritten input in the first input area and a handwritten input in the second input area as different characters.

21. A character recognition apparatus, comprising a processor, the processor being configured to
receive a plurality of handwritten strokes on a screen, the screen having a first input area and a second input area, the first input area and the second input area being partly overlapped; and
allocate the handwritten strokes to either of the first input area or the second input area to recognize first and second characters.
